(19) United States
(12) Patent Application Publication
(10) Pub. No.: US 2019/0342237 A1
(43) Pub. Date: Nov. 7, 2019

(54) Group Information Acquisition Method, Apparatus and Interaction System

(71) Applicant: Alibaba Group Holding Limited, Grand Cayman (KY)

(72) Inventors: Xinglin Ma, Zhejiang (CN); Kai ZHOU, Zhejiang (CN); Rongjun WANG, Zhejiang (CN); Yiran Wang, Zhejiang (CN); Deyan CHE, Zhejiang (CN)

(73) Assignee: Alibaba Group Holding Limited

(21) Appl. No.: 16/513,530

(22) Filed: Jul. 16, 2019

Related U.S. Application Data
(63) Continuation of application No. PCT/CN2018/071756, filed on Jan. 8, 2018.

(30) Foreign Application Priority Data
Jan. 17, 2017 (CN) 201710032060.5

(51) Int. Cl. H04L 12/58; H04W 4/08; H04W 4/21

(52) U.S. Cl. CPC H04L 51/046; H04L 51/20; G06Q 10/109; H04W 4/08; H04W 4/21; H04L 51/32

(57) ABSTRACT

A method, an apparatus, and an interaction system for obtaining group information are provided. The method may include detecting a triggering operation for a group information platform in an interface of a client end of a mobile group work platform; sending a page acquisition request for the group information platform to a server end of the mobile group work platform; and displaying a function page of the group information platform based on page data returned by the server. Using the technical solutions of the present disclosure, processing of internal events of a group can be implemented on a mobile group work platform, while accesses and processing of events external to the group can also be implemented based on connections and communications between the mobile group work platform and a group information platform, thereby realizing quicker information interactions between inside and outside of the same group, and between different groups.

### CROSS REFERENCE TO RELATED PATENT APPLICATIONS

This application claims priority to and is a continuation of PCT Patent Application No. PCT/CN2018/071756 filed on 8 Jan. 2018, and is related to and claims priority to Chinese Patent Application No. 201710032060.5, filed on 17 Jan. 2017 and entitled “Group Information Acquisition Method, Apparatus and Interaction System,” which are hereby incorporated by reference in their entirety.

### TECHNICAL FIELD

The present disclosure relates to the technical field of terminals, and particularly to group information acquisition methods, apparatuses and interactive systems.

### BACKGROUND

In related technologies, mobile group work platforms have become widely used in work processes of a variety of groups such as enterprises, educational institutions, government agencies, etc., which not only can improve the efficiency of communications between users and reduce communication costs, but can also effectively improve the efficiency of processing events and the work efficiency of users.

However, the mobile group work platforms in the related technologies focus on event management within a group, and need to rely on pre-association relationships between groups for information exchanges between the groups. For example, only groups that have mutual understanding and establish a business relationship can conduct communications and interactions through a mobile group work platform.

Accordingly, for groups that have not yet established a business relationship, and even groups that do not know each other, a mobile group work platform in the related technologies apparently cannot satisfy the needs information interactions between these groups, thus resulting in information blocking and poor communications.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In view of this, the present disclosure provides a method and an apparatus, and an interaction system for obtaining group information, which can implement event processing within a group on a mobile group work platform, while being able to implement accesses and processing of events outside the group based on connections and communications between a mobile group work platform and a group information platform, thereby enabling more convenient information interactions between inside and outside of a same group and between different groups.

To achieve the above objectives, the present disclosure provides the following technical solutions.

In implementations, an interactive system for group information is provided, which includes:

a server, the server having a server end of an instant messaging application running therein, the server end being used for maintaining a group information platform;

at least one first type of terminal, the first type of terminal belonging to a first group, wherein the first type of terminal has a client end of the instant messaging application running therein, and the running client end in the first type of terminal is logged into the instant messaging application with a registered account of a group member in the first group; and the first type of terminal detects an information uploading operation for the group information platform according to an interface of the running client end, and uploads group information of the first group to the server, to instruct the server to record the group information of the first group onto the group information platform; and

at least one second type of terminal, the second type of terminal belonging to a second group different from the first group, wherein the second type of terminal has a client of the instant messaging application running therein, and the running client in the second type of terminal is logged into the instant messaging application with a registered account of the group member in the second group; and the second type of terminal detects an information acquisition operation for the group information platform according to an interface of the running client, obtains page data of the group information platform, and displays a function page of the group information platform on the running client in the second type of terminal based on the page data, the function page being used for displaying the group information recorded on the group information platform in a centralized manner.

In implementations, a method for obtaining group information is provided, which includes:

detecting a triggering operation for a group information platform in an interface of a client end of an instant messaging application;

sending a page acquisition request for the group information platform to a server end of the instant messaging application; and

displaying a function page of the group information platform based on page data returned by the server, wherein the function page is used for performing a centralized display of group information on a registered group of the instant messaging application.

In implementations, a method for obtaining group information is provided, which includes:

receiving, by a server end of an instant messaging application, an approval request, the approval request being initiated by a group member of any one registered group on the instant messaging application to another registered group;

generating, by the server end, approval statistical data for at least one registered group according to an approval request for the at least one registered group;

returning, by the server end, page data of a function page of a group information platform to a client end of the instant messaging application in response to receiving a page acquisition request sent by the client end, to cause the client end to display the approval statistical data on the function page, wherein the function page is used for performing a centralized display of group information for the registered group of the instant messaging application.

In implementations, an apparatus for obtaining group information is provided, which includes:

a first detection unit that detects a triggering operation for a group information platform in an interface of a client end of an instant messaging application;

a requesting unit that sends a page acquisition request for the group information platform to a server end of the instant messaging application; and

a first display unit that displays a function page of the group information platform based on page data returned by the server, wherein the function page is used for performing a centralized display of group information for registered group(s) of the instant messaging application.

In implementations, an apparatus for obtaining group information is provided, which includes:

a receiving unit that causes a server end of an instant messaging application to receive an approval request, the approval request being initiated by a group member of any one registered group on the instant messaging application to another registered group;

a generation unit that causes the server end to generate approval statistical data for at least one registered group according to an approval request for the at least one registered group; and

a returning unit that causes the server end to return page data of a function page of a group information platform to a client end of the instant messaging application in response to receiving a page acquisition request sent by the client end, so that the client end is allowed to display the approval statistical data on the function page, wherein the function page is used for performing a centralized display of group information for the registered group of the instant messaging application.

As can be seen from the above technical solutions, by opening a connection between a mobile group work platform and a group information platform, the present disclosure enables a group member of any group to access the group information platform through the mobile group work platform, thus enabling browsing of group information of other groups presented in the group information platform, and thereby implementing acquisitions and interactions of information between groups, without being restricted by the pre-association relationship between the groups. This facilitates a connection to be opened between internal events and external events of a same group, and facilitates communications and information interactions between unfamiliar groups.

### BRIEF DESCRIPTION OF THE DRAWINGS

FIG. 1 is a flowchart of a method for obtaining group information from a perspective of a client end according to an exemplary embodiment of the present disclosure.

FIG. 2 is a flowchart of a method for obtaining group information from a perspective of a server end according to an exemplary embodiment of the present disclosure.

FIG. 3 is a schematic structural diagram of an interaction system of group information provided by an exemplary embodiment of the present disclosure.

FIG. 4A-FIG. 18 are schematic diagrams of interfaces of a client end of a mobile group work platform according to an exemplary embodiment of the present disclosure.

FIG. 19 is a schematic structural diagram of an electronic device from a perspective of a client end according to an exemplary embodiment of the present disclosure.

FIG. 20 is a block diagram of an apparatus for obtaining group information from a perspective of a client end according to an exemplary embodiment of the present disclosure.

FIG. 21 is a schematic structural diagram of an electronic device from a perspective of a server end according to an exemplary embodiment of the present disclosure.

FIG. 22 is a block diagram of an apparatus for obtaining group information from a perspective of a server end according to an exemplary embodiment of the present disclosure.

### DETAILED DESCRIPTION

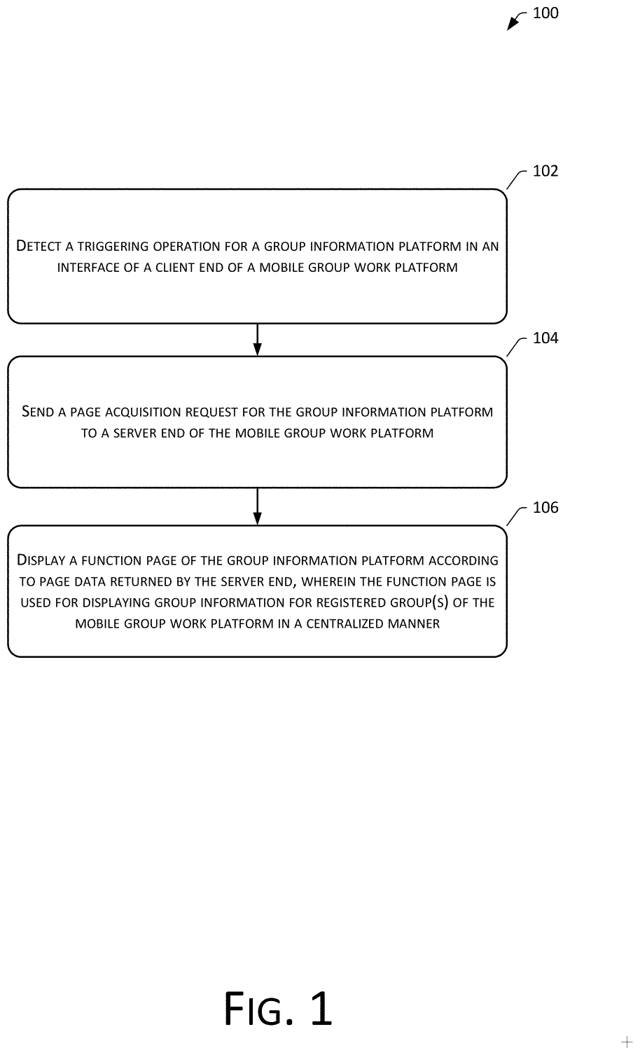

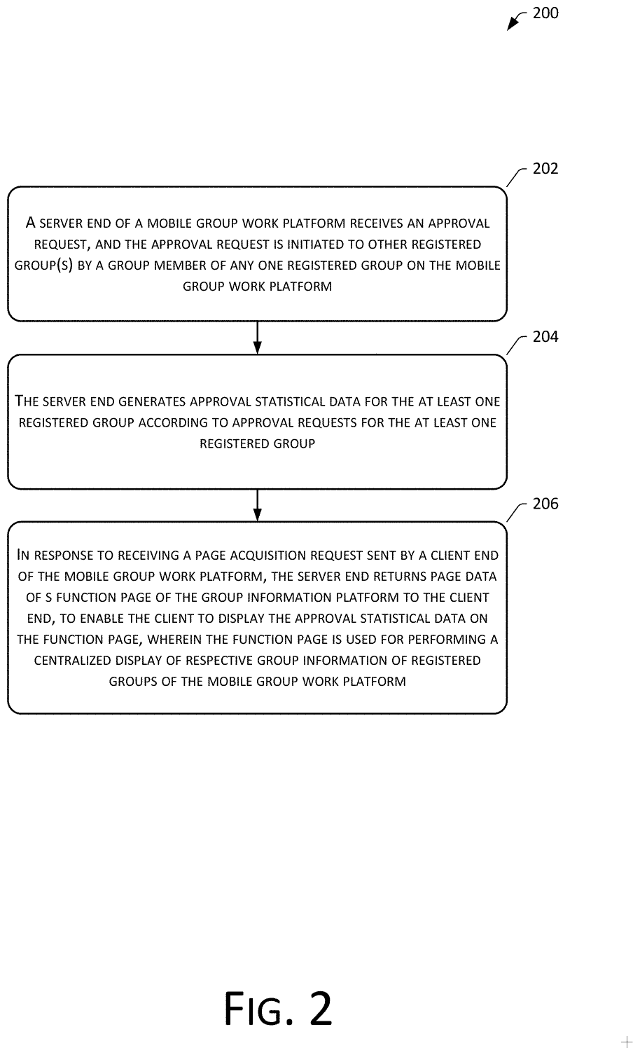

FIG. 1 is a flowchart of a method 100 for obtaining group information from a perspective of a client end according to an exemplary embodiment of the present disclosure. As shown in FIG. 1, the method 100 is applied to a client end of a mobile group work platform running on an electronic device, and may include the following operations.

S102: Detect a triggering operation for a group information platform in an interface of a client end of a mobile group work platform.

In implementations, a mobile enterprise work platform can not only implement communication functions, but also act as an integrated function platform for a number of other functions. Examples are processing of internal events of an enterprise, such as examination and approval events (such as examination and approval events for leave, work item application, financial affairs, etc.), attendance events, task events, and log events, etc., and processing of external events of the enterprise, such as meal ordering, and purchasing, etc., which are not limited in the present disclosure.

More specifically, mobile enterprise work platforms can be hosted in instant messaging applications in related technologies, for example, enterprise instant messaging (EIM) applications, such as Skype For Business®, Microsoft Teams®, Yammer®, Workplace®, Slack®, Enterprise WeChat®, Fxiaoke®, Enterprise Feixin®, Enterprise Yixin®, etc. Apparently, an instant messaging function is only one of a number of communication functions supported by the mobile enterprise work platform. The enterprise work platform can also implement more such as the above other functions, which are not redundantly described herein.

It should be noted that an application program of the client end of the mobile enterprise work platform can be pre-installed on the electronic device, so that the client end can be launched and run on the electronic device. Apparently, when online “client end” using HTML5 technology is used, for example, the client end can be obtained and run without the need of installing the corresponding application program on the electronic device.

In implementations, the client end can detect a triggering operation implemented by a user in a number of ways. For example, in an interface of the client end of the mobile group work platform, an access portal of the group information platform may be displayed. For example, the access portal may be a first-level portal, a second-level portal, or other level, so that a determination can be made that the above triggering operation is detected when the client end detects a clicking operation on the access portal. Apparently, the client end can also detect the triggering operation by detecting a user voice, detecting a touch trajectory generated on the interface of the client end, etc., which are not limited by the present disclosure.

S104: Send a page acquisition request for the group information platform to a server end of the mobile group work platform.

S106: Display a function page of the group information platform according to page data returned by the server end, wherein the function page is used for displaying group information for registered group(s) of the mobile group work platform in a centralized manner.

In implementations, the client end may categorically display corresponding group information on the function page according to a categorization result of registered groups in preset dimension(s) performed by the server end. The preset dimension(s) may include at least one of the following: group categories, an industry to which a group belongs, an area in which the group is located, a status of the group's credit information, a degree of attention, etc., which are not limited in the present disclosure. In other words, through a categorization of registered groups by the server end (which can be pre- categorization or categorization in real time based on the page acquisition request), the user can view group information of other groups without the need of manually performing a query or search operation on the client end (specifically, the function page of the group information platform) on the one hand. On the other hand, through a categorical display of the group information, the user is enabled to quickly determine and view group information of interest, without the need of manual searches or reading traversal, which helps to improve the efficiency of obtaining group information.

In implementations, according to a result of analysis done by the server end regarding supply and demand relationships between a group to which a sender of the page acquisition request belongs and other registered groups, the client end may preferentially display group information of at least one registered group that has a supply and demand relationship with the group of the sender in the function page. In this embodiment, on the one hand, each enterprise should have some needs that cannot be met by itself. The mobile group work platform can determine these needs by performing a big data analysis on historical data of each enterprise. Alternatively, the mobile group work platform can be notified by a management user of each enterprise proactively, so that the server end of the mobile group work platform can know the needs of each enterprise. On the other hand, each enterprise should have business that it can provide or needs that it can satisfy. By the same token, based on the above-mentioned big data analysis or pre-active notification, the server end of the mobile group work platform can know a respective supply condition of each enterprise. Therefore, the sender of the page acquisition request is assumed to be a user A in an enterprise AA (i.e., the client end of the mobile group work platform is logged in with a registered account of the user A), and the server end can find group information of an enterprise BB, for example, that can satisfy the needs of the user A (i.e., registered group(s) having a supply relationship with the enterprise AA) for a supply condition of the enterprise AA. As such, the client end can preferentially display the group information of the enterprise BB, for example, to the user A, thereby quickly realizing group information acquisition and communication interactions between multiple enterprises, and further realizing a cooperation relationship between groups, without the need for the enterprise AA and the enterprise BB to know each other in advance. Similarly, the server end can also search for group information of an enterprise CC, etc., having a related demand for this supply (i.e., registered group(s) having a demand relationship with the enterprise AA) for the supply condition of the enterprise AA. As such, the client end can preferentially display the group information of the enterprise CC and the like to the user A. Therefore, group information acquisition and communication interactions between multiple enterprises can be quickly realized, and a cooperation relationship between groups can further be realized, without the need for the enterprise AA and the enterprise CC to know each other in advance.

In implementations, the client end may display a corresponding object supply list in the function page according to a result of statistics performed by the server end regarding object supply information from at least one registered group. The object supply information is information of object(s) that can be provided by the corresponding group. For example, the enterprise AA can provide an object 1, the enterprise BB can provide an object 2, etc. Displaying such object supply information in the object supply list helps members of other groups to perform browsing, and obtain group information of a corresponding group by selecting and triggering respective object supply information, thus further realizing interactions and communications with the corresponding group.

In implementations, the client end may display a corresponding object demand list in the function page according to a result of statistics performed by the server end regarding object demand information from the at least one registered group. The object demand information is information of object(s) that is/are needed by the corresponding group. For example, the enterprise AA needs an object 3 as a production raw material, the enterprise BB needs an object 4, etc. Displaying such object demand information in the object demand list helps members of other groups to perform browsing, and obtain group information of a corresponding group by selecting and triggering respective object supply information, thus further realizing interactions and communications with the corresponding group.

In implementations, the client end may display approval statistical data of any one registered group conducted by the server end in the function page, and the approval statistical data is computed and obtained by the server end based on approval requests sent by group members of other registered groups for the any one registered group. The approval statistical data may include at least one of: a total number of approval requests for the any one registered group, personal information of senders of the approval requests for the any one registered group, message information of the senders of the approval requests for the any one registered group, group information of respective groups to which the senders of the approval requests belong for the any one registered group, etc. Apparently, the present disclosure does not have any limitations thereon. In implementations, when the enterprise member A of the enterprise AA initiates an approval request for the enterprise BB, this indicates that the enterprise member A approves the enterprise BB, for example, considers that products and services provided by the enterprise BB are excellent. Therefore, under the circumstance that the enterprise member A and the enterprise AA to which the enterprise member A belongs support and endorse the enterprise BB, especially when the enterprise member A or the enterprise AA has relatively high degrees of publicity and credibility, other users or groups that have not yet contacted and understood the enterprise BB can quickly establish trust in the enterprise BB, and quickly establish interactions and association relationships with the enterprise BB. This helps to accelerate mutual understanding between unfamiliar groups and enhance the efficiency of communications between unfamiliar groups.

Furthermore, restriction(s) may be set for initiating an approval request, for example, restricting a certification level of a group to which a sender of the approval request belongs is restricted to reach a preset level, wherein the certification level is positively correlated with a degree of details of registration information of the group to which the sender belongs in the mobile group work platform, thereby avoiding some groups from by establishing some low-level groups to perform “making an order”, and ensuring the authenticity and reliability of the approval statistical data.

In implementations, the client end may send communication demand information for any one registered group to the server end. The client end may then receive contact information of an intermediate communication party returned by the server end. The intermediate communication party has one or more levels of association relationship with a sender of the communication demand information and at least one contact of the any one registered group respectively. An association relationship between the intermediate communication party and the sender is used as an example. When a direct association relationship exists between the intermediate communication party and the sender, for example, the contact information of the intermediate communication party exists in a contact list of the sender, a first-level association relationship is considered to exist between the intermediate communication party and the sender. If the intermediate communication party does not exist in the contact list of the sender, but a contact person recorded in the contact list of the sender has a direct association with the intermediate party (e.g., when a method of contact of the intermediate communication party exists in a contact list of such contact person), the intermediate communication party and the sender have a second-level relationship, and so on. An association relationship between the intermediate communication party and the at least one contact of the any one registered group is similar, and is not redundantly described herein. In implementations, by providing the intermediate communication party, the sender of the communication demand information is no longer in an unfamiliar relationship with the any one registered party, and establishing a plurality of levels of association relationships based on the intermediate communication party is equivalent to converting a social network of strangers into a social network of acquaintances, which helps to reduce the difficulty of communications and improve the efficiency of communications.

In implementations, the client end may send a business card delivery request for any one registered group to the server end. The business card delivery request is used for instructing the server end to obtain contact information of a sender of the business card delivery request, and transmitting the contact information to a management member of the any one registered group. As such, when the management member responds to the contact information, an association relationship between the sender of the business card delivery request and the management member is established. In implementations, by sending a business card delivery request to the server end, the server end can send corresponding contact information to a management member of a corresponding registered group on the one hand, thereby helping to quickly establish an association relationship between a sender of the business card delivery request and the management member. On the other hand, the management member can actively determine whether to respond to the contact information that is received to avoid being disturbed by unrelated persons.

In implementations, the client end may display a service window page of any one registered group in response to detecting a triggering operation for group information of the any one registered group that is displayed in the function page. The service window page includes a function identifier of a preset processing function that is associated with the any one registered group. Upon detecting a user operation for the function identifier, the client end may then initiate an information interaction request to the server end to implement an operation of information interaction for the preset processing function. In implementations, a service window may be presented as a respective window page of a corresponding group that is used for implementing a preset processing function, and the window page includes a function identifier corresponding to the preset processing function. Therefore, the corresponding preset processing function can be implemented by a user with an application authority to trigger the function identifier. In other words, any group can allow members of other groups to trigger a function identifier in its own service window page (e.g., based on the user operation as described above) by presenting the service window page to the other groups. In this way, an operation of information interaction for a preset processing function can be implemented between the any group and the other groups.

In implementations, the information interaction request may be used for instructing the server end to create a communication session between an initiator of the user operation and a specific group member of the any one registered group, or between the initiator and an information processing system of the any one registered group to implement an information interaction operation based on the communication session. Apparently, other than the communication session, other forms of information interaction operations, such as creating a product order, querying a historical order, etc., may be implemented, which are not limited by the present disclosure.

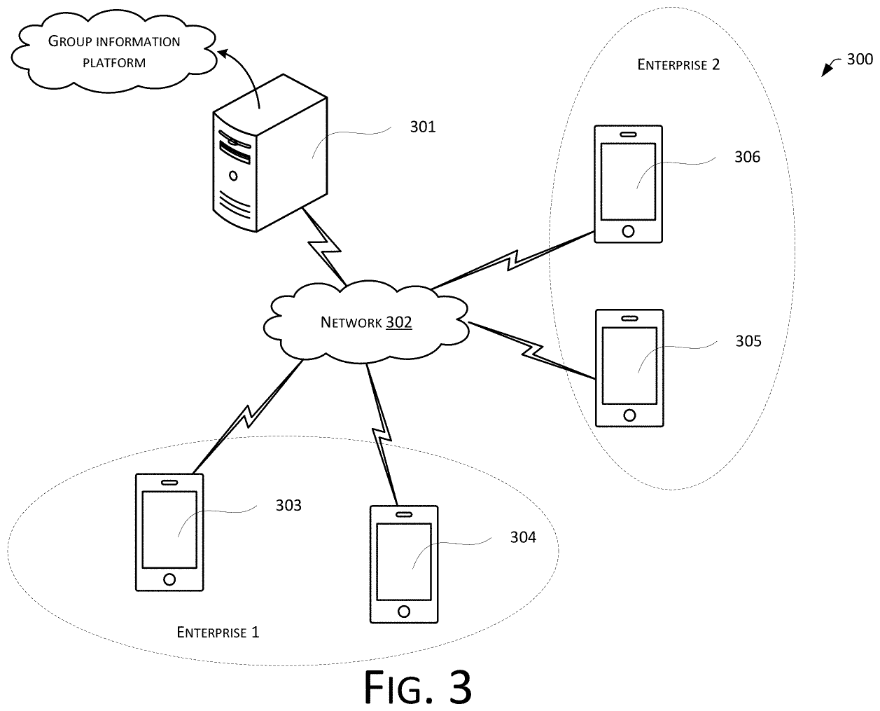

Correspondingly, FIG. 2 is a flowchart of a method 200 for obtaining group information from a perspective of a server end according to an exemplary embodiment of the present disclosure. As shown in FIG. 2, the method 200 is applied in a server end of a mobile group work platform, and may include the following operations.

S202: A server end of a mobile group work platform receives an approval request, and the approval request is initiated to other registered group(s) by a group member of any one registered group on the mobile group work platform.

In an embodiment, group members of registered groups may directly initiate approval requests for another registered group, and the server end may generate approval statistical data of the other registered group based on the approval requests.

In another embodiment, the server end may receive an approval invitation issued by a group member of another registered group. When a target party of the approval invitation is configured as a group member of the any one registered group, the approval invitation is sent to the group member of the any one registered group, so that the group member of the any one registered group performs an invitation prompt on a specific client end corresponding to the mobile group work platform. The server end then receives a prompt response message returned by the specific client end. The prompt response message includes the approval request. In other words, with the enterprise AA as an example, the user A in the enterprise AA can initiate approval invitations to group members of other enterprises such as the enterprise BB, the enterprise CC, etc., to invite them to initiate approval requests to the enterprise AA, without the need of group members of other enterprises such as the enterprise BB and the enterprise CC, etc. to take the initiative, thus promoting the efficiency of the enterprise AA's recognition.

S204: The server end generates approval statistical data for the at least one registered group according to approval requests for the at least one registered group.

In implementations, the approval statistical data may include at least one of: a total number of approval requests for the any one registered group, personal information of senders of the approval requests for the any one registered group, message information of the senders of the approval requests for the any one registered group, group information of respective groups to which the senders of the approval requests belong for the any one registered group, etc. Apparently, the present disclosure does not impose any limitations thereon. In implementations, when the enterprise member A of the enterprise AA initiates an approval request for the enterprise BB, this indicates that the enterprise member A recognizes and approves the enterprise BB, for example, approving that products and services provided by the enterprise BB are excellent. Therefore, under the circumstance that the enterprise member A and the enterprise AA to which the enterprise member A belongs support and endorse the enterprise BB, especially when the enterprise member A or the enterprise AA has relatively high degrees of publicity and credibility, other users or groups that have not yet contacted and understood the enterprise BB can quickly establish trust in the enterprise BB, and quickly establish interactions and association relationships with the enterprise BB. This helps to accelerate mutual understanding between unfamiliar groups and enhance the efficiency of communications between unfamiliar groups.

S206: In response to receiving a page acquisition request sent by a client end of the mobile group work platform, the server end returns page data of s function page of the group information platform to the client end, to enable the client to display the approval statistical data on the function page, wherein the function page is used for performing a centralized display of respective group information of registered groups of the mobile group work platform.

In implementations, when a certification level of the any one registered group does not reach a preset level, the server end may ignore the approval request initiated by the group member of the any one registered group, or set a restriction on an authority of group members of the any one registered group to initiate authorization requests. The certification level is positively correlated with a level of details of registration information of the any one registered group on the mobile group work platform, thereby preventing some groups from establishing low-level groups to “make an order” to ensure the authenticity and reliability of the approved statistical data.

As can be seen from the above technical solutions, by opening a connection between a mobile group work platform and a group information platform, the present disclosure enables a group member of any group to access the group information platform through the mobile group work platform, thus enabling browsing of group information of other groups presented in the group information platform, and thereby implementing acquisitions and interactions of information between groups, without being restricted by the pre-association relationship between the groups. This facilitates a connection to be opened between internal events and external events of a same group, and facilitates communications and information interactions between unfamiliar groups.

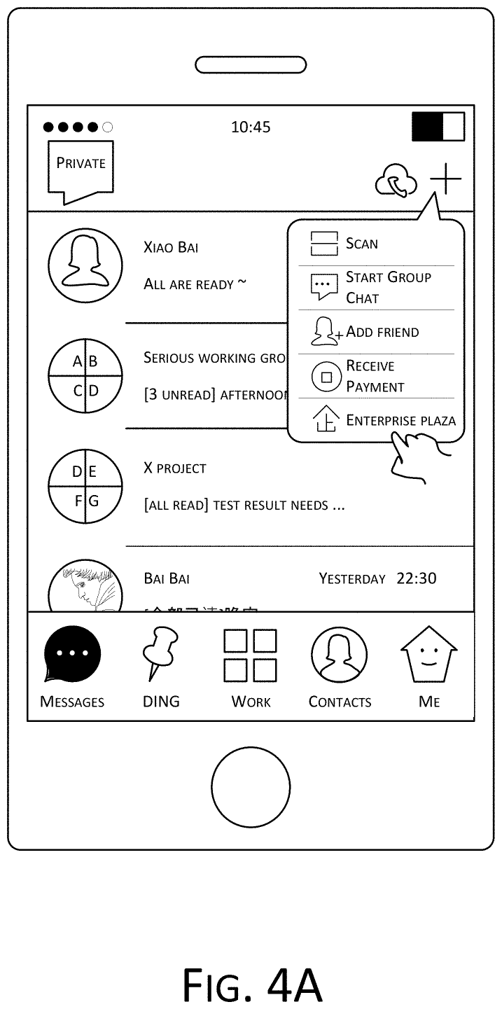

FIG. 3 is a schematic structural diagram of an interaction system 300 of group information provided by an exemplary embodiment of the present disclosure. As shown in FIG. 3, the system 300 may include a server 301, a network 302, and a number of electronic devices, such as mobile phones 303, 304, 305, and 306.

The server 301 may be a physical server including an independent host machine. Alternatively, the server 301 may be a virtual server hosted by a cluster of host machines. Alternatively, the server 301 may be a cloud server. During operations, the server 301 can run a server-side program of a certain application to implement related service functions of the application. For example, when the server 301 runs a program of a mobile group work platform, a server end of the mobile group platform can be implemented. In the technical solutions of the present disclosure, the server 301 runs a group information platform, and manages group information on the group information platform in a centralized manner, which includes recording and maintaining group information from various groups, and implements interactions and processing of group information among multiple groups.

The mobile phones 303-306 are just one type of electronic devices that users can use. In practice, users apparently can also use electronic devices such as tablet devices, notebook computers, PDAs (Personal Digital Assistants), wearable devices (such as smart glasses, smart watches, etc.), etc., which are not limited by the present disclosure. During operations, the electronic device can run a client-side program of a certain application to implement related service functions of the application, such as a network certification function as described above.

For the network 302 through which the mobile phones 303-306 and the server 301 conduct interactions, a variety of types of wired or wireless networks may be included. In an embodiment, the network 302 may include a PSTN (Public Switched Telephone Network) and the Internet. At the same time, electronic devices such as the mobile phones 303-306 can also conduct communications through the network 302, for example, to establish a single-chat communication session between any two electronic devices. Alternatively, a number of electronic devices can participate in a same group chat communication session, thus enabling any user to send a communication message to all other users in the group chat communication session through his/her own electronic device. For example, when the group chat communication session is an inter-group communication session between multiple groups, groups members in these groups can conduct group chat communications through this inter-group communication session.

The mobile phones 303-306 have client ends of the mobile group work platform running therein, and the client ends are logged in with registered accounts (i.e., registered accounts in the mobile group work platform) of respective users. When the registered accounts that are logged on the mobile phones 303-304 come from group members of a group 1, this indicates that the mobile phones 303-304 are configured to belong to the group 1. For example, all electronic devices belonging to the group 1 are “terminals of a first type”. When registered accounts that are logged on the mobile phones 305-306 come from group members of a group 2, this indicates that the mobile phones 305-306 are configured to belong to the group 2. For example, all electronic devices belonging to the group 2 are “terminals of a second type”.

Broadly speaking, the group 1 and the group 2 as described above can serve as two groups that are arbitrarily and mutually distinguished from each other. The terminal of the first type and the terminal of the second type can be used as electronic devices respectively corresponding to two groups that are arbitrarily and mutually distinguished from each other. Each group member in a group can communicate with the server through electronic devices belonging to the group, thereby realizing information interactions with the group information platform. For example, a group member in the group 1 can communicate with the server through a terminal of a first type to upload and record group information of the group 1 in the group information platform. A group member in the group 2 can conduct communications with the server through a terminal of a second type to obtain page data corresponding to the group information platform. Therefore, by displaying a function page corresponding to the page data on the terminal of the second type, the group member in the group 2 can view the group information that is recorded on the group information platform (which includes, for example, group information of the group 1 and other groups) on the function page in a centralized displaying manner. As such, the group information of the group 1 or other groups is obtained. Similarly, the group member of the group 2 can also upload and record group information of the group 2 onto the group information platform, and the group 1 obtains the group information of the group 2 from the group information platform. Details thereof are not described again herein.

In order to help understanding, an instant messaging application is used as an example. An instant messaging client end is assumed to be run in the mobile phone 303, and an enterprise WeChat server end is assumed to be run in the server 301. The instant messaging client on the mobile phone 303 is logged in with a registered account of a user, i.e., the mobile phone 303 is configured as the user's instant messaging client end. A process of obtaining group information using the mobile phone 303 by an enterprise member A in a certain enterprise is used as an example below to describe the technical solutions of the present disclosure in detail.

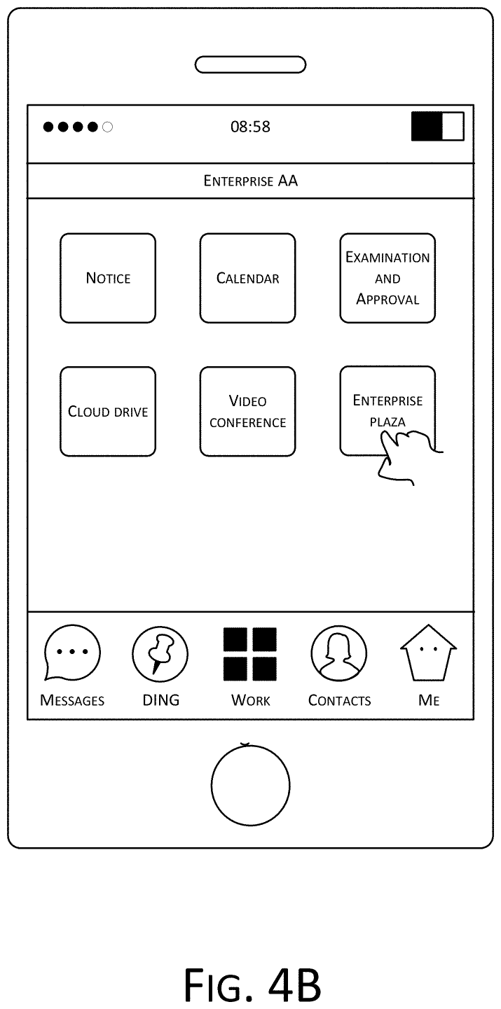

In a client interface of the instant messaging client end running on the mobile phone 303, a triggering portal to a group information platform can be provided. For example, as shown in FIG. 4A, a session list page (which is used for displaying a session page portal of all communication session pages of a logged-in user, i.e., the enterprise member A, on the instant messaging client end, such as portals of session pages in FIG. 4A are displayed in a vertical arrangement) of the instant messaging client end, a temporary window as shown in FIG. 4A can be called in response to detecting a triggering operation of the enterprise member A on an identifier “+” at the upper right corner. A triggering portal of the group information platform can be expressed as an “enterprise plaza” in the temporary window. Apparently, the triggering portal of the group information platform can also take other forms. For example, in a “work” tab page as shown in FIG. 4B, an “enterprise plaza” icon may further be added as a triggering portal for the group information platform as described above, in addition to icons of internal management functions of the enterprise, such as “notice”, “calendar”, and “examination and approval”, etc., that are supported by the instant messaging client end. Alternatively, in a contact page as shown in FIG. 4C, in addition to “WeChat friends” and “mobile address book”, and “my group”, an “enterprise plaza” project may also be added as a triggering portal for the group information platform as described above.

It can be understood that the group information platform is used for displaying group information of all registered groups of the “enterprise WeChat” in a centralized manner. When focusing on registered groups of an “enterprise” type, it is equivalent to displaying enterprise information of all registered enterprises of the “enterprise WeChat” in a centralized manner, from which the “enterprise plaza” as described above is constructed.

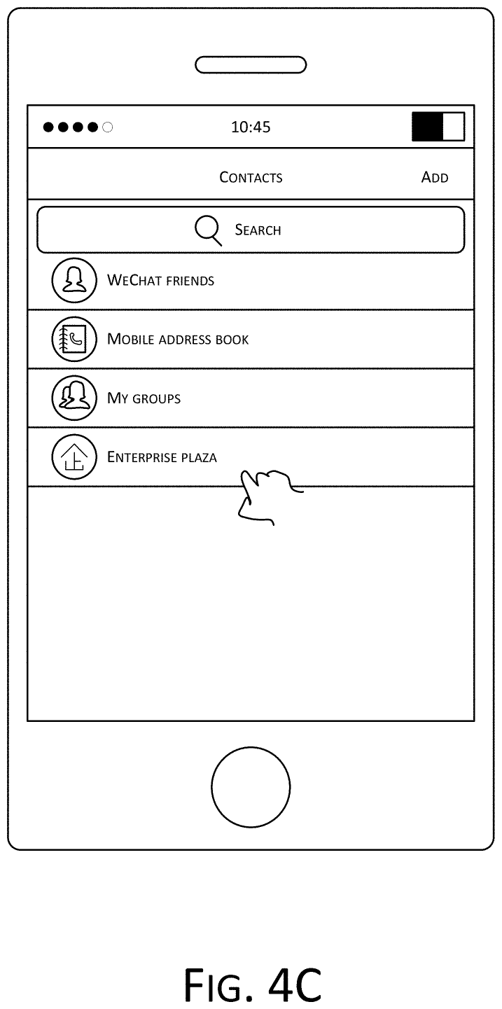

After the enterprise member A triggers the triggering portal of the group information platform, the instant messaging client end may first display a personal management page as shown in FIG. 5. The personal management page includes a “what I follow” tab page. A page portal for displaying enterprise homepages of enterprises that are of interest to the enterprise member A. For example, when the enterprise member A pays attention to the enterprise BB, a page portal of the enterprise BB is shown in FIG. 5, and the “what I follow” tab page can further display recommendation information for enterprise homepages of other enterprises such as “Alibaba”, “Baidu”, “Tencent”, etc. These recommended enterprises can be enterprises having the highest degree of concern, the most recognized enterprises, or other types of enterprises (which are not limited by the present disclosure), in order to guide the enterprise member A to browse and pay attention to the enterprise homepages of these recommended enterprises.

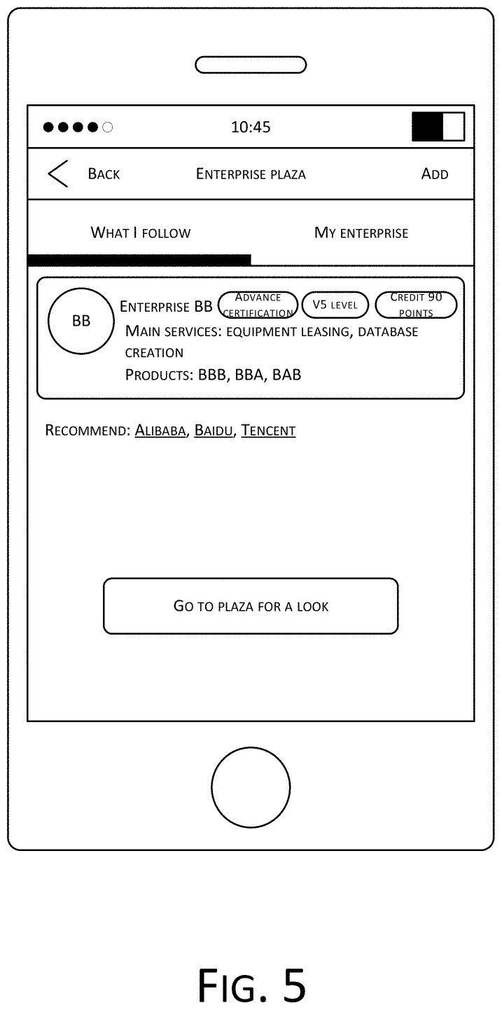

In response to detecting that a triggering operation of the enterprise member A for “go to plaza for a look” as shown in FIG. 5, the instant messaging client end may send a page acquisition request to the enterprise WeChat server end running on the server 301, and display an enterprise plaza page (i.e., a function page of the group information platform) as shown in FIG. 6 based on page data returned by the server end, to collectively display group information of registered groups in the enterprise WeChat. Apparently, the personal management page shown in FIG. 5 may not be essential. When the enterprise member A triggers a triggering portal of the group information platform in any form as shown in FIGS. 4A-4C, the instant messaging client end can directly display the enterprise plaza page as shown in FIG. 6.

In the enterprise plaza page, by displaying the group information of the registered groups of the enterprise WeChat, the enterprise member A can browse the group information of these registered groups through the enterprise plaza page to determine whether communication or cooperation, etc. with these registered groups is needed, without the need of knowing any information of these registered groups in advance. Apparently, although the enterprise plaza page can display group information of all registered groups to allow the enterprise member A to traverse and browse, a problem of exceedingly low efficiency may be resulted when the number of registered groups is large. Therefore, in order to improve the browsing efficiency of the enterprise member A, and reduce or avoid browsing of unrelated group information, the present disclosure proposes further improvements to the solutions:

The server end of the enterprise WeChat can classify registered groups in preset dimension(s) in advance, and send the aforementioned page data including a classification result to the instant messaging client end on the mobile phone 303, and the instant messaging client end can categorically display group information of the registered groups in an enterprise plaza page such as shown in FIG. 6 based on the classification result.

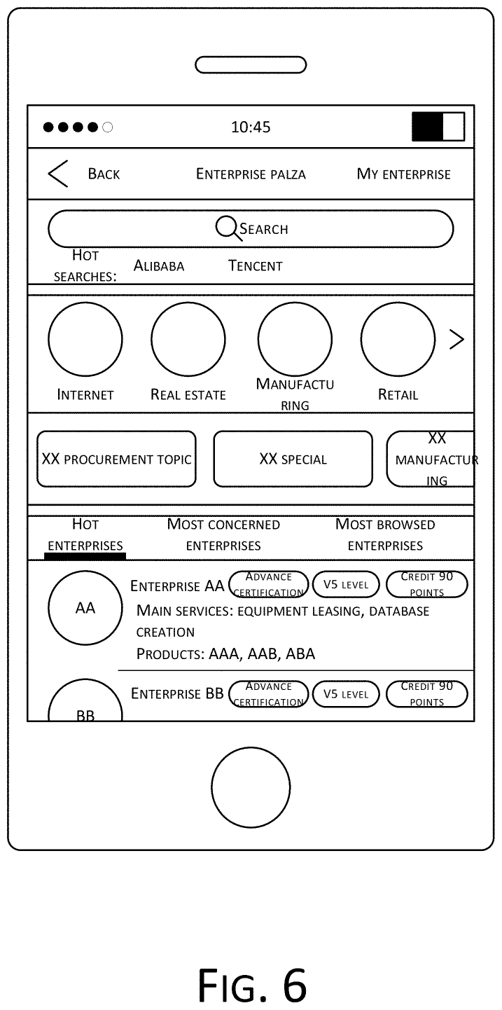

In an embodiment, the preset dimension(s) may include an industry to which a group belongs, such as the Internet, real estate, manufacturing, retail, etc., so that the instant messaging client end may display classification icons for industries such as the Internet, real estate, manufacturing, retail, etc., in the enterprise plaza page as shown in FIG. 6, and when any of these classification icons is triggered, display all registered groups under a corresponding classification. For example, when the enterprise member A wishes to entrust an Internet company to create a database, the enterprise member A can browse and view group information of registered groups of the Internet industry as shown in FIG. 7 by triggering an “Internet” icon as shown in FIG. 6, without having to browse classifications such as “real estate”, etc., thus improving the efficiency of obtaining the group information.

In another embodiment, the preset dimension(s) may include a degree of attention. For example, the enterprise WeChat server end may set a number of ranges of degrees of attention, and group registered groups according to respective degrees of attention corresponding to each registered group. Therefore, the instant messaging client can display the “most concerned enterprises” in the enterprise plaza page as shown in FIG. 6, i.e., registered groups within a range of the highest degree of attention, and display thereof in a descending order of respective degrees of attention. Similarly, the “most browsed enterprises” as shown in FIG. 6 may also be displayed. Specifically, when the preset dimension(s) include(s) the number of times of browsing, the enterprise WeChat server end groups registered groups according to a number of ranges of the number of times of browsing that are configured, and the instant messaging client end then displays registered groups in a range of the highest number of times of browsing. Apparently, the “hot enterprises” as shown in FIG. 6 may also be included, which can be demarcated by the enterprise WeChat server end according to another dimension, and details thereof are not redundantly described herein.

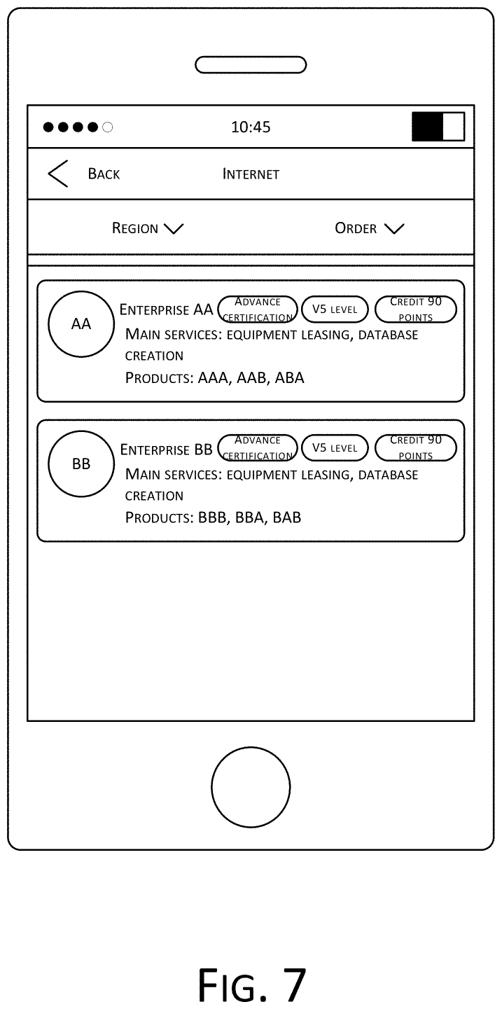

In still another embodiment, the preset dimension(s) may include some temporary customized dimensions. For example, for a procurement event of XX material, the enterprise WeChat server end may create a “XX procurement” dimension, and concentrate registered groups related to “XX procurement” into “XX procurement topic”, which is equivalent to classifying registered groups into being “related to XX procurement” and being “not related to XX procurement”. The instant messaging client end displays group information of the registered groups that are “related to XX procurement” in a centralized manner on a “XX procurement topic” page as shown in FIG. 8. Similarly, the enterprise plaza page may also display other “special” or “topic” such as “XX special”, “XX manufacturing . . .”, etc., as shown in FIG. 6, which are not exhaustively described herein.

In addition, the enterprise WeChat server end can also classify registered groups through other arbitrary dimensions, e.g., group categories (such as enterprises, schools, hospitals, government agencies, public security departments, etc.), regions in which the groups are located (such as provinces, counties, and cities, etc.), group credit status (for example, dividing registered groups into groups according to score ranges in which respective credit scores are located, wherein credit data of each group can be generated by the platform of the enterprise WeChat, or provided by an associated third-party credit rating platform).

Apparently, for each of the preset dimensions that are described above, other than classifying the registered groups according to a single preset dimension, the enterprise WeChat server end can also perform more detailed classification processing through multiple preset dimensions at the same time. For example, after classifying according to an “industry to which a group belongs”, it is assumed that the enterprise member A selects the “Internet” category and is transferred to a page shown in FIG. 7. This page may include a “region” option, so that the enterprise member A can select one or more preset regions (such as countries, provinces, counties, etc.) by triggering the “region” option to select and display registered groups that satisfy both the “Internet” category and the selected region(s), which is equivalent to performing classification for the registered groups at the same time through an “industry to which a group belongs” and a “geographical location in which a group is located”.

In the pages as shown in FIGS. 6-8, group information of each group can be displayed separately. The “enterprise AA” is used as an example. Group information displayed in an outline form may include an icon, a name, main service(s), product(s), etc. of the enterprise AA, and label information configured by the enterprise WeChat for the enterprise AA. For example, an “Advance Certification” indicates that the enterprise AA's certification level on the enterprise WeChat is “Advanced” (a certification level is positively correlated with a level of details of registration information of a corresponding group on the mobile group work platform of the enterprise WeChat), a “V5 rating” indicates that the certification level of the enterprise AA is the fifth level in “Advanced”, and “Credit 90 points” is a credit score of the enterprise AA. Apparently, the group information displayed in the outline form may include only a part of the above content, and may also contain more other content, which is not limited in the present disclosure.

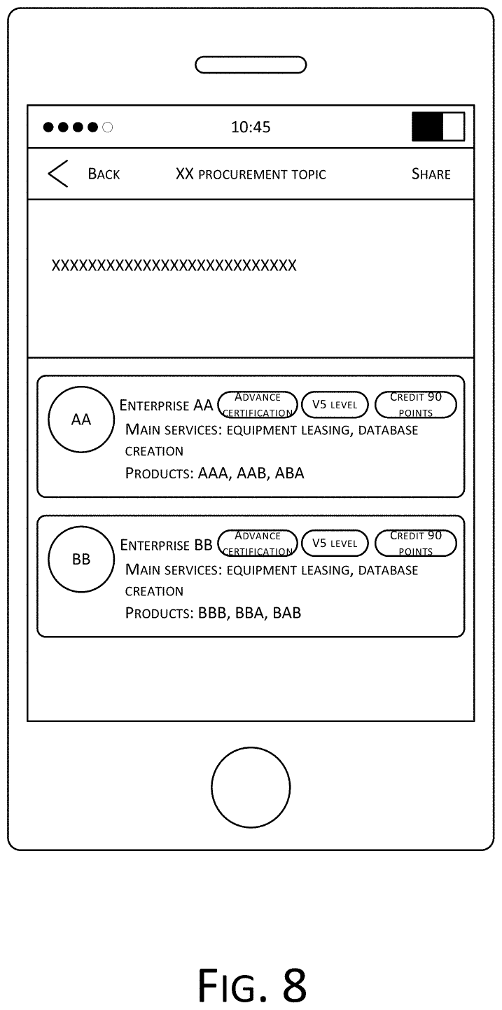

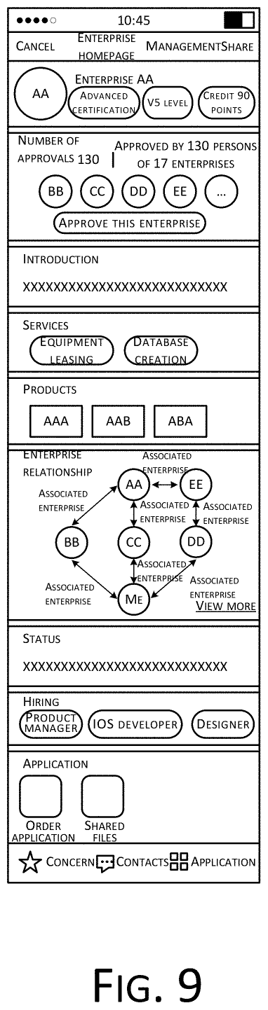

When the enterprise member A triggers outlined group information of any group in FIGS. 6-8 or other pages, the instant messaging client end can display detailed group information of any group. For example, when the enterprise AA or the outlined group information corresponding to the enterprise AA is triggered, an enterprise homepage as shown in FIG. 9 may be displayed. The detailed group information of the enterprise AA is displayed in the enterprise homepage (i.e., group information of the enterprise AA is displayed in detail). Regardless of what relationship between the enterprise member A and the enterprise AA is (for example, the enterprise member A belonging to the enterprise AA, or the enterprise member A not belonging to the enterprise AA), the enterprise member A can find the enterprise AA or its corresponding outlined group information through the enterprise plaza, and the enterprise homepage as shown in FIG. 9 is triggered and displayed. In addition, when the enterprise member A does not belong to the enterprise AA, the enterprise AA may be added as an enterprise that is concerned by the enterprise member A by triggering a “Concern” option on the left side of the enterprise homepage as shown in FIG. 9. In this case, the personal management page as shown in FIG. 5 can display a page portal corresponding to the enterprise homepage of the enterprise AA. When the enterprise member A belongs to the enterprise AA, the enterprise member A may select and open a “My enterprise” tab page in the personal management page. The content of the tab page is shown in FIG. 10. For example, when the enterprise member A belongs to both the enterprise AA and the enterprise AB at the same time, page portals of respective enterprise homepages corresponding to the enterprise AA and the enterprise AB can be displayed in the tab page. In response to detecting that the enterprise member A triggers the “enterprise AA’ as shown in FIG. 10, switching to the enterprise homepage of the enterprise AA, such as the one shown in FIG. 9, can be directly made.

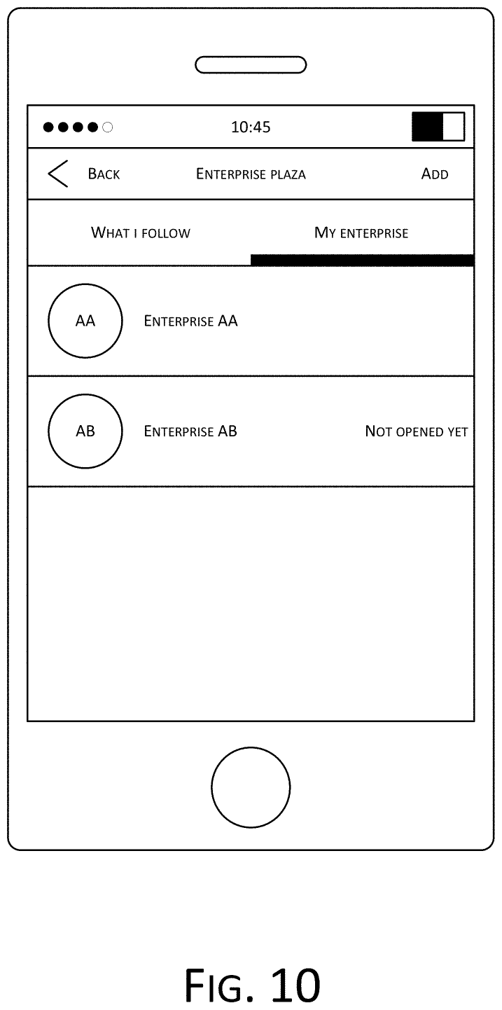

Apparently, not group information of all registered groups is displayed in the enterprise plaza. The enterprise AA is used as an example. When a management member of the enterprise AA (i.e., enterprise members with administrative privileges, such as business administrators, etc.) opens the enterprise homepage of the enterprise AA through the instant messaging client end, the enterprise homepage may include a management portal (other enterprise members of the enterprise AA, enterprise members of other enterprises, and persons not belonging to any enterprise, etc., are unable to view and manipulate this management portal). For example, a “management’ option included at the top of the enterprise homepage as shown in FIG. 9 can be used as the management portal. When the instant messaging client end detects that the management portal is triggered, an enterprise management homepage as shown in FIG. 11 may be displayed. The management page includes a “promote enterprise homepage to enterprise plaza” option, and the management member can choose to show the enterprise AA in the enterprise plaza, or not to show the enterprise AA in the enterprise plaza, through a configuration operation for this option. Furthermore, through a “persons who have already concerned about” option as shown in FIG. 11, the management member can also view persons who have already concerned about the enterprise AA (for example, by triggering the “concern” option at the bottom of the enterprise homepage as shown in FIG. 9), in facilitate the management member to communicate with these persons who have added concerns, or views group information of respective groups to which these persons belong.

As shown in FIG. 9, the enterprise homepage of the enterprise AA includes an “approve this enterprise” option, and an “approval” function of the present disclosure can be realized through this option. More specifically, when a group member of any one registered group browses an enterprise home page of another registered group (for example, an enterprise member A from an enterprise X browses the enterprise home page of the enterprise AA), the instant messaging client end can send an approval request to the enterprise WeChat server end (which indicates that the enterprise member A approves the enterprise AA), when the instant messaging client end detects the “approve this enterprise” option on the enterprise homepage is triggered. The enterprise WeChat server end can count all approval requests for the enterprise AA, and display corresponding approval statistical data on the enterprise homepage of the enterprise AA. For example, the approval statistical data may include at least one of the following, which apparently are not limited by the present disclosure:

The total number of approval requests for the enterprise AA. For example, as shown in FIG. 9, when the enterprise WeChat server end receives 130 approval requests for the enterprise AA, this may mean that a corresponding “approval number” is 130.

Group information of respective groups to which senders of the approval requests for the enterprise AA. For example, as shown in FIG. 9, the enterprise WeChat server end can count the number of attribution groups of the senders of the approval request. For example, when these senders are come from 17 enterprises respectively, “accepted by 130 persons of 17 enterprises” can be displayed, and information of associated enterprises such as icons, names, etc., can be shown. For example, these enterprises can be an enterprise BB, an enterprise CC, an enterprise DD, an enterprise EE, etc. When the number of enterprises is too many, only information associated with some enterprises can be shown, while others are omitted by “ . . . ”. Apparently, users can view information associated with all enterprises by triggering “ . . . ”.

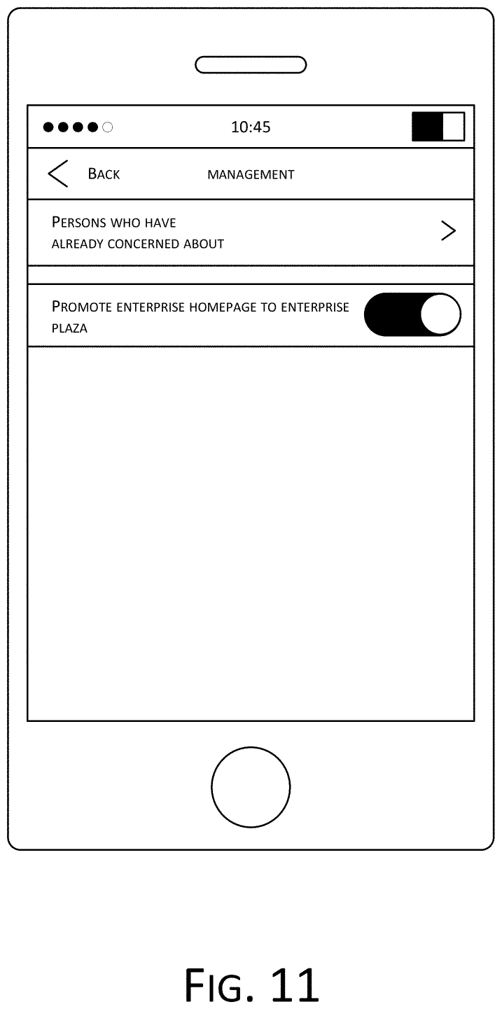

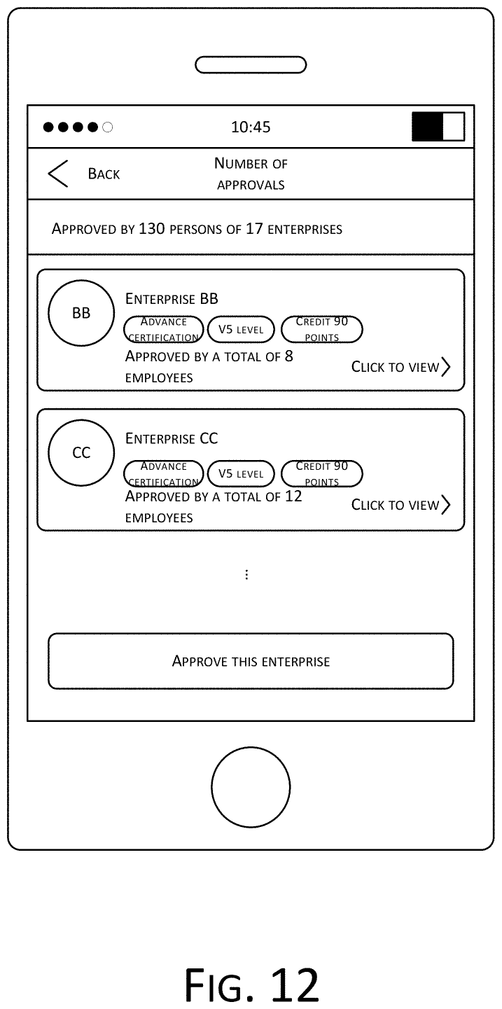

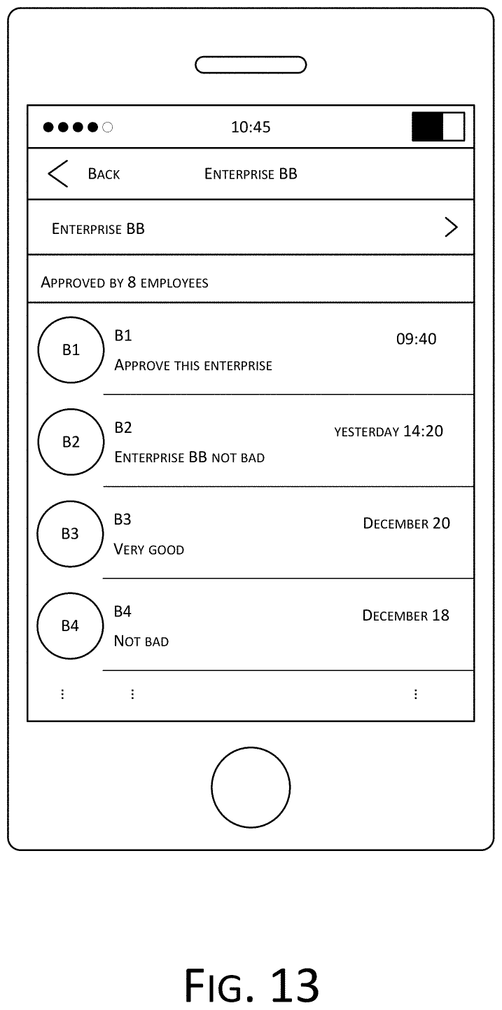

Personal information of the senders of the approval requests for the enterprise AA. Although the instant messaging client end can display personal information of all the senders in the enterprise homepage as shown in FIG. 9, too many display areas may be occupied. Therefore, after detecting the triggering operation for the above “ . . . ”, information of the enterprises to which the senders belong is shown using a list page as shown in FIG. 12. For enterprise(s) that is/are selected in the list page, personal information of senders of such enterprise(s) who approve the enterprise AA is further displayed. For example, when an enterprise BB is selected, head images and names of an enterprise member B1 and an enterprise member B2, etc. in the enterprise BB, time points at which approval requests are sent, etc., may be displayed on a page as shown in FIG. 13, to indicate that these enterprise members in the enterprise BB approve the enterprise AA.

Message information of the senders of the approval requests for the enterprise AA. As shown in FIG. 13, the enterprise member B1 in the enterprise BB is used as an example. Message information such as “approve this enterprise” may be added to indicate that it is not a random click or an erroneous operation when an approval request is sent, from which the approved reliability is increased. Apparently, the message information may be manually inputted by a sender of an approval request, or the sender may manually select available message information that is pre-generated, thereby simplifying an input operation of the sender.

By adopting the above-mentioned “approval” operation, persons who send an approval request and respective groups to which the persons belong can provide a certain degree of endorsement and guarantee for groups that are approved and recognized thereby, especially for some groups that are established for a short period of time and are not well known. If they can be approved and recognized by well-known persons or groups, this will obviously enhance the reputation and credibility of these groups, facilitate a development of these groups, and facilitate a development of cooperation with other groups.

In an embodiment, the enterprise WeChat may allow all users to ratify other groups outside their own groups. In another embodiment, the enterprise WeChat may impose certain restrictions on users who send approval requests, for example, a certification level of a group to which a sender of an approval request belongs needs to reach a preset level (such as “advanced certification; and “intermediate certification”, “primary certification”, “uncertified”, etc., may also be included, where certification levels: advanced certification>intermediate certification>primary certification>uncertified). A certification level is positively correlated with a level of details of registration information of a group to which a sender belongs on the enterprise WeChat.

The enterprise AA is still used as an example. Other than a user actively initiating an “approval” operation of the enterprise AA during a process of browsing the enterprise homepage of the enterprise AA, an enterprise member of the enterprise AA may also initiate an invitation to enterprise member(s) of other enterprise(s), to invite them to ratify the enterprise AA. The enterprise homepage as shown in FIG. 9 is used as an example. In response to detecting that a user triggers the “approve this enterprise” option, the user may initiate an approval request for the enterprise AA if the user does not belong to the enterprise AA. If the user is an enterprise member of the enterprise AA, a process of inviting an approval for the enterprise AA may be evoked, so that the user can send an invitation for approving the enterprise AA to any associated user. When the user sends the approval invitation to the associated user through the enterprise WeChat server end, the associated user may be an enterprise WeChat friend of the user, and an instant messaging client end used by the associated user may provide an invitation prompt for this approval invitation. According to a response operation of the associated user with respect to the invitation prompt, the enterprise WeChat server end may receive prompt response information returned by the instant messaging client end used by the associated user. The prompt response information may include an approval request for the enterprise AA. Apparently, the user can also share the approval invitation to other mobile group work platforms or communication applications (such as instant messaging applications) other than the enterprise WeChat server end. In this case, the approval invitation does not need to be sent by the enterprise WeChat server end.

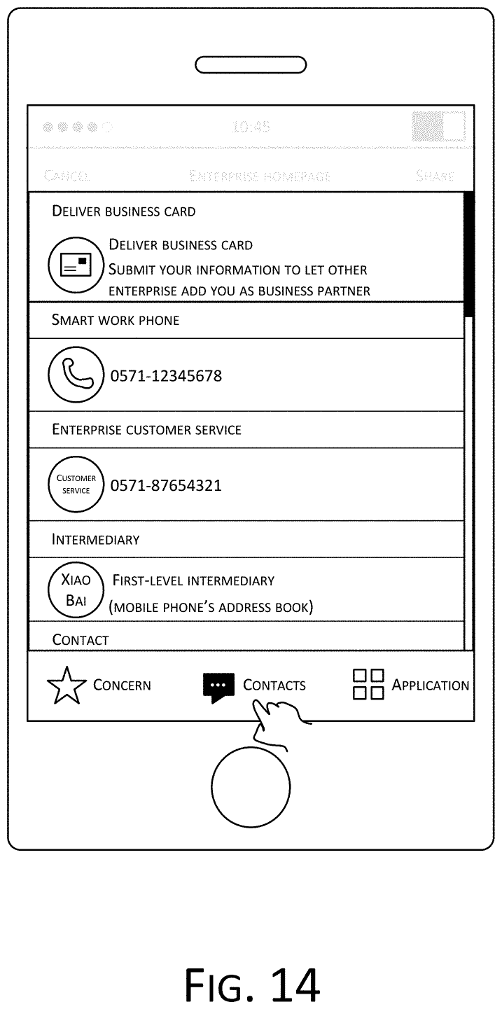

For example, the enterprise homepage of the enterprise AA shown in FIG. 9 is taken as an example. In response to detecting that the user triggers a “contact” option at the bottom, a temporary window as shown in FIG. 14 can be called, and information displayed in the temporary window is used for conducting communications between the user and the enterprise AA. For example, the temporary window as shown in FIG. 14 may directly display ways of communication, such as a “smart work phone” and a “enterprise customer service”, etc., of the enterprise AA, and may also display contact information of a “contact person” inside the enterprise AA. As such, the user can communicate with an enterprise member in the enterprise AA through the “smart work phone”, the “enterprise customer service”, the contact information, and the like.

As shown in FIG. 14, the temporary window may include a “delivery of business card” option. In response to detecting that the user performs a triggering operation on this option, the instant messaging client end may send a business card delivery request to the enterprise WeChat server end, to cause the server to determine contact information of the user who has logged onto instant messaging client end, and send the contact information to a management member (or another preset enterprise member) of the enterprise AA. As such, the management member can establish an association relationship with the user when responding to the contact information. For example, the user is added as a personal friend of the management member. Alternatively, the user is added as an external contact of the enterprise AA, and the external contact information can be shared with other enterprise members in the enterprise AA who have browsing rights (browsing rights for external contact information), so that association relationships can be quickly established between the user and the enterprise members in the enterprise AA to realize communications.

When the user triggers the “contact” option and invokes the temporary window as shown in FIG. 14 (or at other times), the instant messaging client end can send communication demand information for the enterprise AA to the enterprise WeChat server end. In this case, the enterprise WeChat server end can return contact information of an intermediate communication party, which appears as an “intermediary” in the temporary window as shown in FIG. 14, to the instant messaging client end. The intermediate communication party has one or more levels of association relationship with the user (i.e., a sender of the communication demand information) and at least one enterprise member in the enterprise AA, so that a relationship between the user and the enterprise AA is converted from “unfamiliar social content” to “acquaintance social contact”, which helps to improve the efficiency of communications between two parties. For example, if the logged-in user on the instant messaging client end has an associated user “Xiao Bai” in a mobile phone address book, a first-level association relationship between the logged-in user and the user “Xiao Bai” exists. When a mobile phone address book or other address book of the user “Xiao Bai” has a user “Bai Bai” who is an enterprise member of the enterprise AA, a first-level relationship between the user “Xiao Bai” and the user “Bai Bai” exists. In this case, the logged-in user can be connected to the user “Bai Bai” through the user “Xiao Bai”. In other words, the logged-in user can be connected to the enterprise AA through the user “Xiao Bai”, thereby forming a relationship chain of the logged-in user ->the user “Xiao Bai”->the enterprise AA (the user “Bai Bai”). Therefore, the user “Xiao Bai” is a first-level intermediary between the logged-in user and the enterprise AA.

Similarly, if the mobile phone address book of the logged-in user on the WeChat client end includes an associated user “Xiao Bai”, a mobile phone address book or other address books of “Xiao Bai” includes a user “Xiao Hei”, a mobile phone address book or other address books of “Xiao Hei” includes a user “Bai Bai”, and the user “Bai Bai” is an enterprise member of the enterprise AA, then the logged-in user has a first-level association relationship with the user “Xiao Bai”, and has a second-level relationship between with the user “Xiao Hei”. The user “Bai Bai” has a first-level relationship with the user “Xiao Hei”, and a second-level relationship with the user “Xiao Bai”. Accordingly, a relationship chain of the logged-in user ->the user “Xiao Bai” ->the user “Xiao Hei” ->the enterprise AA (the user “Bai Bai”) is formed. Therefore, the user “Xiao Bai” is a first-level intermediary between the logged-in user and the enterprise AA. The user “Xiao Hei” is a second-level intermediary between the logged-in user and the enterprise AA.

In addition to adopting the “intermediary” form as described above, i.e., besides a relationship transfer based on a user dimension, relationship transfers can also be performed based on other dimensions, which is not limited in the present disclosure. For example, a relationship transfer can be performed based on an enterprise dimension. As shown in FIG. 9, for example, when a user from a certain enterprise X views the enterprise homepage of the enterprise AA, the enterprise homepage may include an “enterprise relationship” to indicate an enterprise relationship between the enterprise X (i.e., “I” that is labeled in FIG. 9) and the enterprise AA. Especially when no direct relationship between the enterprise X and the enterprise AA exists, this can help the user to determine how to establish an association relationship between the enterprise X and the enterprise AA. For example, as shown in FIG. 9, by labeling each enterprise as a corresponding node and indicating an association relationship between corresponding enterprises through a “two-way arrow” between adjacent nodes, the user is enabled to quickly determine an indirect association relationship between the enterprise X and the enterprise AA. If the enterprise X has association relationships with the enterprise BB, the enterprise CC, and the enterprise DD, etc. (i.e., the enterprise BB, the enterprise CC, the enterprise DD are associated enterprises of the enterprise X), and if the enterprise BB and the enterprise CC, etc., have association relationships with the enterprise AA, then the enterprise BB and the enterprise CC have first-level relationships with the enterprise X respectively. The enterprise X can establish an association relationship with the enterprise AA based on this first-level association relationship, thereby helping the user to quickly establish an association relationship between the enterprise X and the enterprise AA. Although the enterprise DD does not have a direct association relationship with the enterprise AA, the enterprise EE has association relationships with the enterprise DD and the enterprise AA at the same time. Therefore, a first-level relationship between the enterprise DD and the enterprise X exists, and a second-level relationship between the enterprise EE and the enterprise X exists. The enterprise X can establish an association relationship with the enterprise AA based on such first-level association relationship and second-level association relationship.

Apparently, the “intermediary”, the “enterprise relationship”, etc., as described above, may be located at any position in a homepage of an enterprise, or may be located at a same position in the homepage of the enterprise, and may also be displayed in conjunction with relationship transfer information in even more dimensions in the homepage of the enterprise, on which the present disclosure does not have any limitations.

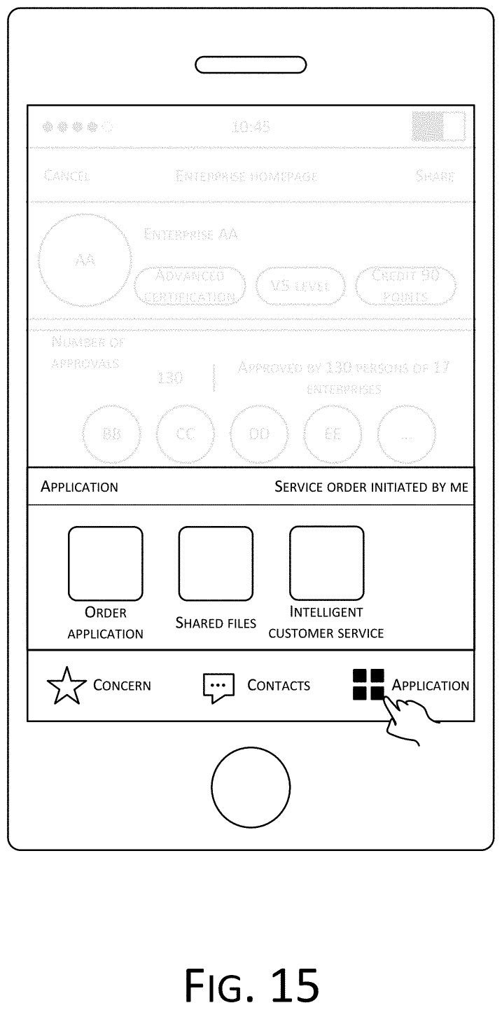

For example, the enterprise homepage of the enterprise AA as shown in FIG. 9 is still used as an example. In response to detecting that the user triggers an “application” option at the bottom, a temporary window as shown in FIG. 15 may be invoked, and the temporary window includes icons of a plurality of preset processing functions, such as “order application”, and “shared files”, “intelligent customer service”, etc.

For example, when the user triggers the “order application”, the instant messaging client end may display a corresponding order application page, and generate order application information according to content inputted by the user. The instant messaging client end then sends the order application information to the enterprise WeChat server end for processing, to complete the order application.

When the user triggers the “shared files”, the instant messaging client end can initiate an access to the enterprise WeChat server end to access a shared storage space of the enterprise AA on the enterprise WeChat server end, and view shared files therein. Apparently, if the shared storage space has opened up data write permission, the user can also upload and store any file into the shared storage space.

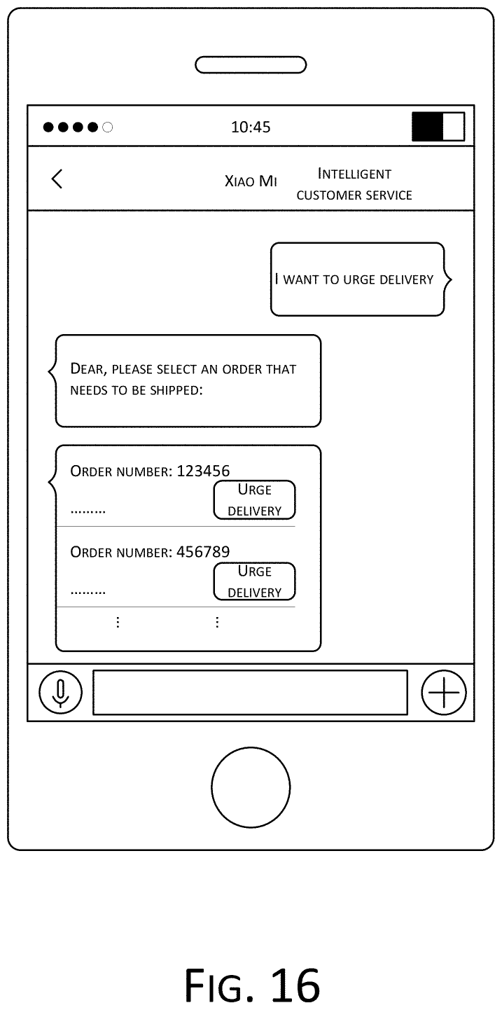

When the user triggers “intelligent customer service”, the instant messaging client end can send an intelligent customer service request to the enterprise WeChat server end, and the enterprise WeChat server end can establish a communication session between the instant messaging client end and an intelligent customer service system of the enterprise AA. The user can communicate with the intelligent customer service system in the communication session page as shown in FIG. 16, for example. The user can send an inquiry message to the intelligent customer service system of the enterprise AA through the communication session page as shown in FIG. 16, for example, and the intelligent customer service system can return a corresponding reply to the inquiry. For example, when the inquiry message is “I want to urge delivery”, a reply to the inquiry returned by the intelligent customer service system may include “Dear, please select an order that needs to be shipped:”, and shows order(s) that the user has created in the enterprise AA and is/are not shipped yet.

In implementations, in addition to the intelligent customer service system, cross-enterprise inquiry communications can be realized between the instant messaging client end and the customer service personnel in the enterprise AA. For example, according to a customer service request initiated by the instant messaging client end (corresponding to the above intelligent customer service request), the enterprise WeChat server end can determine a specific customer service staff to communicate with the logged-in user of the instant messaging client end from among customer service staffs in the enterprise AA. A communication session is established between the specific customer service staff and the instant messaging client end, so that a cross-enterprise communication between the specific customer service staff and the logged-in user can be realized through the communication session.

Furthermore, the enterprise WeChat not only provides an inter-group communication solution between internal and external contacts of a group (such as the communication session between the logged-in user of the instant messaging client end and the intelligent customer service system of the enterprise AA or the specific customer service staff), a task management solution within the group can also be provided, so that group members within the group can handle matters according to a task mode.

For example, when the inquiry message sent by the logged-in user is “I want to urge delivery”, the enterprise WeChat server end can determine orders that are created by the enterprise AA and are not yet shipped, and directly issue corresponding processing tasks to enterprise members in the enterprise AA who are associated with these orders. For example, if an enterprise member Z in the enterprise AA is responsible for a delivery operation of an associated order, a corresponding delivery task can be issued to the enterprise member Z, thereby realizing an association and opening a connection between inside and outside of the enterprise, thus helping to improve the processing efficiency.

Apparently, in the reply to the inquiry as shown in FIG. 16, a corresponding “urge delivery” option can also be displayed at a place by each order, so that the logged-in user can trigger a corresponding order by triggering an associated “urge delivery” option, to implement an operation of urging delivery for the corresponding order. Then, the enterprise WeChat server end can issue a delivery task to the corresponding enterprise member Z in the enterprise AA according to the order that is triggered. For an order that is not triggered, a task may not be issued by the enterprise WeChat server end.

In implementations, for a delivery mode of the delivery task, the server may send a reminder message (such as a DING message) with a task attribute to the enterprise member Z. The task attribute of the reminder message is manifested by including a task deadline and a need of returning a corresponding task processing condition before the task deadline.

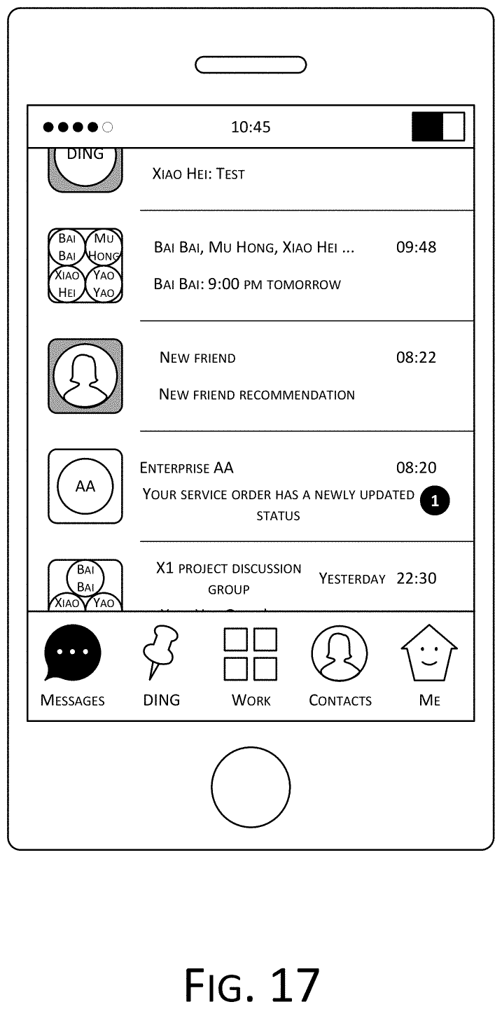

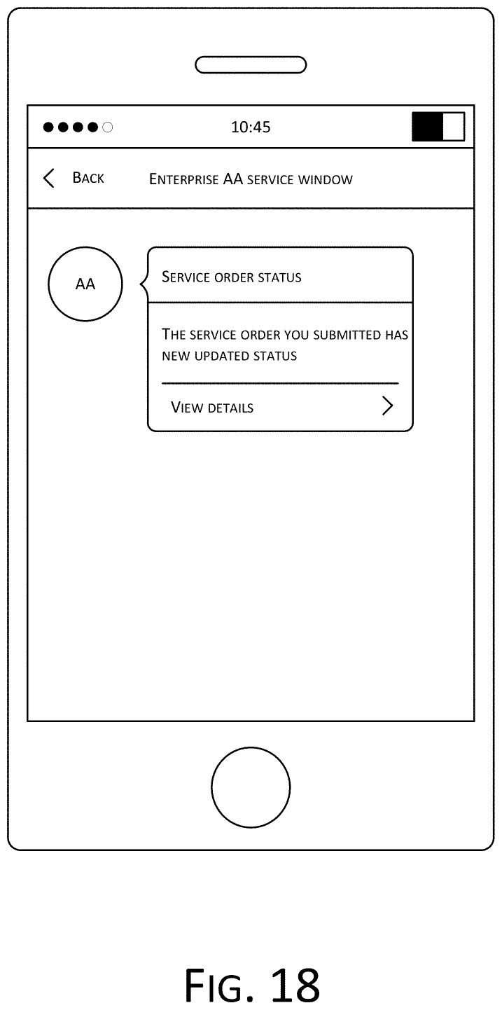

As such, the server can push a corresponding notification message to an enterprise user B according to the task processing situation that is returned by the enterprise user Z through a device 3. For example, as shown in FIG. 17, a message list page of the enterprise WeChat on the mobile phone 303 used by the user may include a function page portal corresponding to a service window of the enterprise AA, and the function page portal may shows prompt information for the notification message. In this case, when the user triggers the prompt information, the corresponding notification message may be displayed in an “enterprise AA service window” page as shown in FIG. 18 (i.e., a communication session between the user and the service window of the enterprise AA). Apparently, the user can also trigger the notification message as shown in FIG. 18 to jump to the enterprise homepage or related function page of the enterprise AA, and specifically display and view details of the notification message, which are not described in detail herein.

Apparently, besides the notification message related to the processing task, the server may send any form of notification message to an external contact having an application authority through the service window of the enterprise AA, which is not limited in present disclosure. Therefore, the enterprise AA can uniformly perform a message push to all external contacts having application authority through the enterprise homepage, without separately communicating with each external contact through a chat window, thus greatly simplifying the complexity of operations and improves the efficiency of communication.

In the technical solutions of the present disclosure, when any group is registered to the enterprise WeChat, the enterprise WeChat can know supply and demand conditions of the group, i.e., products or services needed by the group, products or services provided by the group, etc. Therefore, by obtaining and analyzing supply and demand conditions of all registered groups, the enterprise WeChat server end can obtain supply and demand relationships between the registered groups. The enterprise AA is used as an example. If main services of the enterprise AA are “equipment leasing” and “database creation”, and products thereof are AAA, AAB, ABA, etc., while another enterprise FF needs products AAA and AAB, the enterprise AA can then be determined to have a supply relationship with the enterprise FF. Another enterprise KK can provide manufacturing raw materials of the products AAA and AAB, and the enterprise AA can be determined to have a demand relationship with the enterprise KK. As such, after analyzing supply and demand relationships among the enterprise AA, the enterprise FF, and the enterprise KK, etc., an instant messaging client end sends an analysis result of the supply and demand relationships that is generated to instant messaging client ends of enterprise members of the enterprise AA. When the enterprise members of the enterprise AA view the enterprise plaza (such as the one shown in FIG. 6), the instant messaging client ends can preferentially display enterprise information of the enterprise FF and the enterprise KK, etc., which have supply and demand relationships with the enterprise AA, without the need of the enterprise members to look through or perform a search actively, thus helping to improve the efficiency of communications between enterprises with supply and demand relationships, and reduce communication costs.

In short, by opening a connection between a mobile group work platform and a group information platform, the present disclosure enables a group member of any group to access the group information platform through the mobile group work platform, thus enabling browsing of group information of other groups presented in the group information platform, and thereby implementing acquisitions and interactions of information between groups, without being restricted by the pre-association relationship between the groups. This facilitates a connection to be opened between internal events and external events of a same group, and facilitates communications and information interactions between unfamiliar groups.

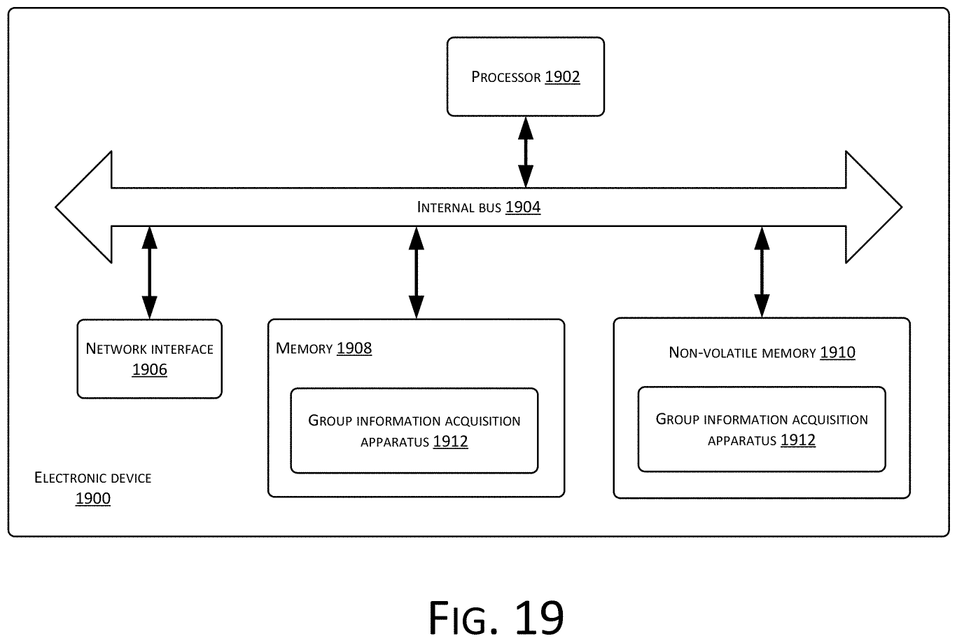

FIG. 19 shows a schematic structural diagram of an electronic device 1900 according to an exemplary embodiment of the present disclosure. Referring to FIG. 19, at the hardware level, the electronic device 1900 includes a processor 1902, an internal bus 1904, a network interface 1906, a memory 1908, and a non-volatile memory 1910. Apparently, hardware components needed by other services may also be included. The processor 1902 reads a corresponding computer program from the non-volatile memory 1910 into the memory 1902 and then operates to form an apparatus 1912 for obtaining group information on the logical level. Apparently, in addition to software implementations, the present disclosure does not exclude other means of implementation, such as a logic device or a combination of software and hardware, etc. In other words, an execution body of the following flow of processing is not limited to each logical unit, and may be hardware component(s) or logic device(s).

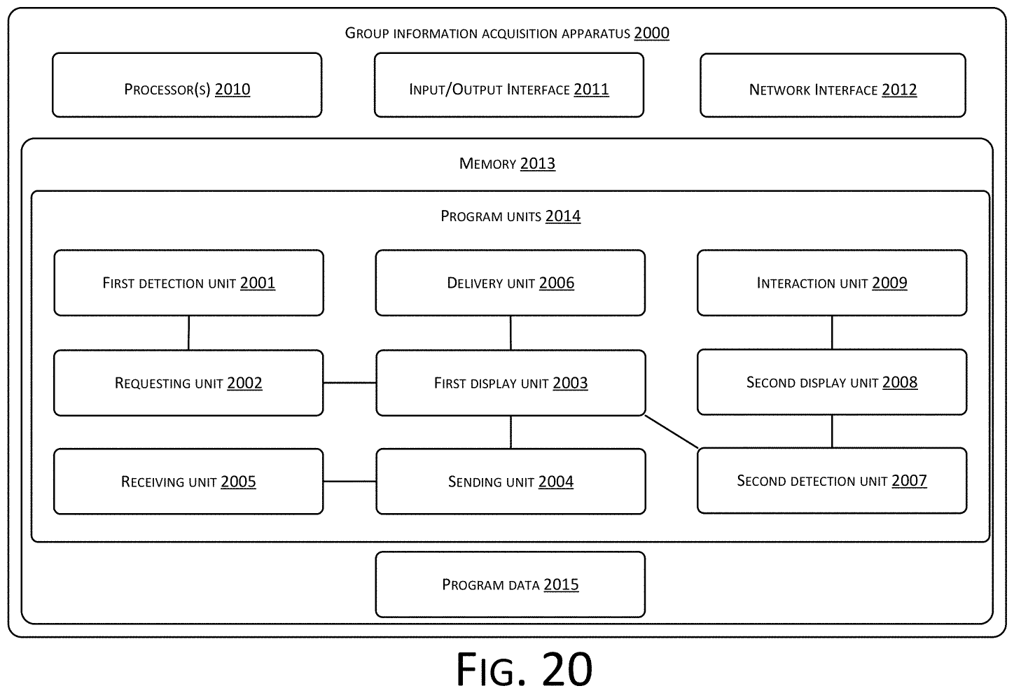

Referring to FIG. 20, an apparatus 2000 for obtaining the group information may include a first detection unit 2001, a requesting unit 2002, and a first display unit 2003, wherein:

a first detection unit 2001 detects a triggering operation for a group information platform in an interface of a client end of a mobile group work platform;

a requesting unit 2002 sends a page acquisition request for the group information platform to a server end of the mobile group work platform; and

a first display unit 2003 displays a function page of the group information platform based on page data returned by the server end, wherein the function page is used for performing a centralized display of group information for registered group(s) of the instant messaging application.

In implementations, the first display unit 2003 is specifically configured to:

categorically display corresponding group information on the function page according to a classification result of the registered group(s) by the server end on preset dimension(s).

In implementations, the preset dimension(s) include(s) at least one of the following:

a type of a group, an industry to which the group belongs, a region in which the group is located, a group credit status, and a degree of concern.

In implementations, the first display unit 2003 is specifically configured to:

preferentially display group information of at least one of registered groups having a supply relationship and registered groups having a demand relationship with a group to which a sender of the page acquisition request belongs in the function page according to an analysis result obtained by the server end regarding supply and demand relationships between the group to which the sender belongs and other registered groups.

In implementations, the first display unit 2003 is specifically configured to:

display approval statistical data made by the server end for any one registered group in the function page, the approval statistical data being statistically calculated by the server according to approval requests of group members of other registered groups that are sent for the any one registered group.

In implementations, the approval statistical data includes at least one of the following:

a total number of the approval requests for the any one registered group, personal information of senders of the approval requests for the any one registered group, and message information of the senders of the approval requests for the any one registered group, group information of respective groups to which the senders of the approval requests for the any one registered group are located.

In implementations, a certification level of a group to which the sender of the approval request belongs reaches a preset level, wherein the certification level is positively correlated with a level of details of registration information of the group of the sender on the mobile group work platform.

In implementations, the apparatus 2000 also includes:

a sending unit 2004 that sends communication demand information for any one registered group to the server end; and

a receiving unit 2005 that receives contact information of an intermediate communication party returned by the server end, the intermediate communication party having one or more levels of association relationships with a sender of the communication demand information and at least one contact of the any one registered group respectively.

In implementations, the apparatus 2000 also includes:

a delivery unit 2006 that sends a business card delivery request for any one registered group to the server end, the business card delivery request being used for instructing the server end to obtain contact information of a sender of the business card delivery request, and send the contact information to a management member of the any one registered group, so that an association relationship is established between the sender of the business card delivery request and the management member when the management member responds to the contact information.

In implementations, the apparatus 2000 also includes:

a second detection unit 2007 that detects a triggering operation for group information of any one registered group that is displayed in the function page;

a second display unit 2008 that displays a service window page of the any one registered group, the service window page including a function identifier of a preset processing function related to the any one registered group; and

an interaction unit 2009 that initiates an information interaction request to the server end to implement an information interaction operation for the preset processing function in response to detecting a user operation for the function identifier.

In implementations, the information interaction request is used for instructing the server end to create a communication session between an initiator of the user operation and a specific group member of the any one registered group, or between the initiator and an information processing system of the any one registered group to implement the information interaction operation based on the communication session.

In implementations, the apparatus 2000 may further include one or more processors 2010, an input/output (I/O) interface 2011, a network interface 2012, and a memory 2013.

The memory 2013 may include a form of computer readable media such as a volatile memory, a random access memory (RAM) and/or a non-volatile memory, for example, a read-only memory (ROM) or a flash RAM. The memory 2013 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 2013 may include program units 2014 and program data 2015. The program units 2014 may include one or more of the foregoing units as described above and as shown in FIG. 20.

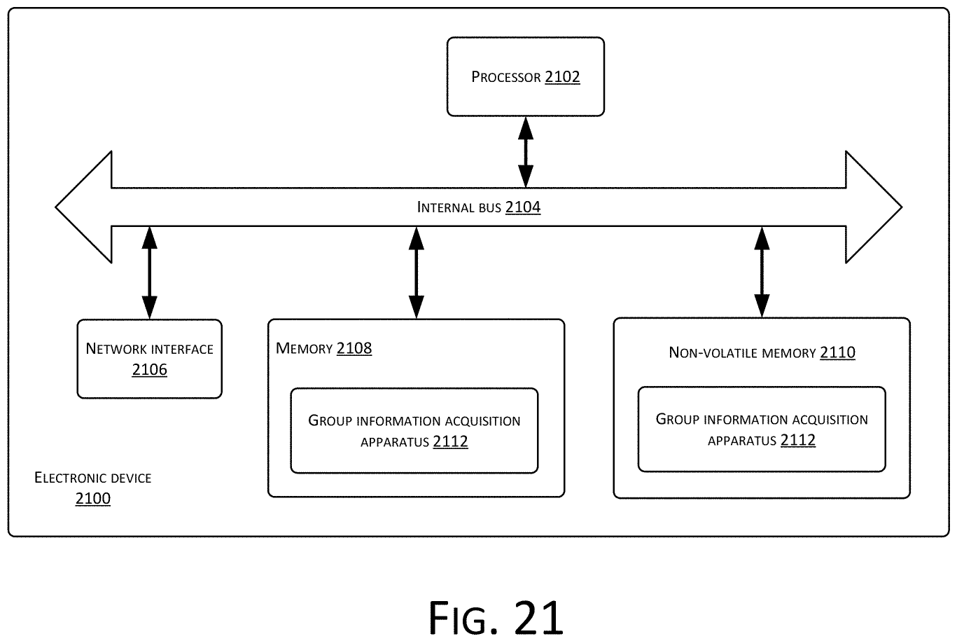

FIG. 21 shows a schematic structural diagram of an electronic device according to an exemplary embodiment of the present disclosure. Referring to FIG. 21, at the hardware level, the electronic device includes a processor 2102, an internal bus 2104, a network interface 2106, a memory 2108, and a non-volatile memory 2110. Apparently, hardware components needed by other services may also be included. The processor 2102 reads a corresponding computer program from the non-volatile memory 2110 into the memory 2102 and then operates to form an apparatus for obtaining group information on the logical level. Apparently, in addition to software implementations, the present disclosure does not exclude other ways of implementation, such as a logic device or a combination of software and hardware, etc. In other words, an execution body of the following processing flow is not limited to each logical unit, and may be hardware component(s) or logic device(s).

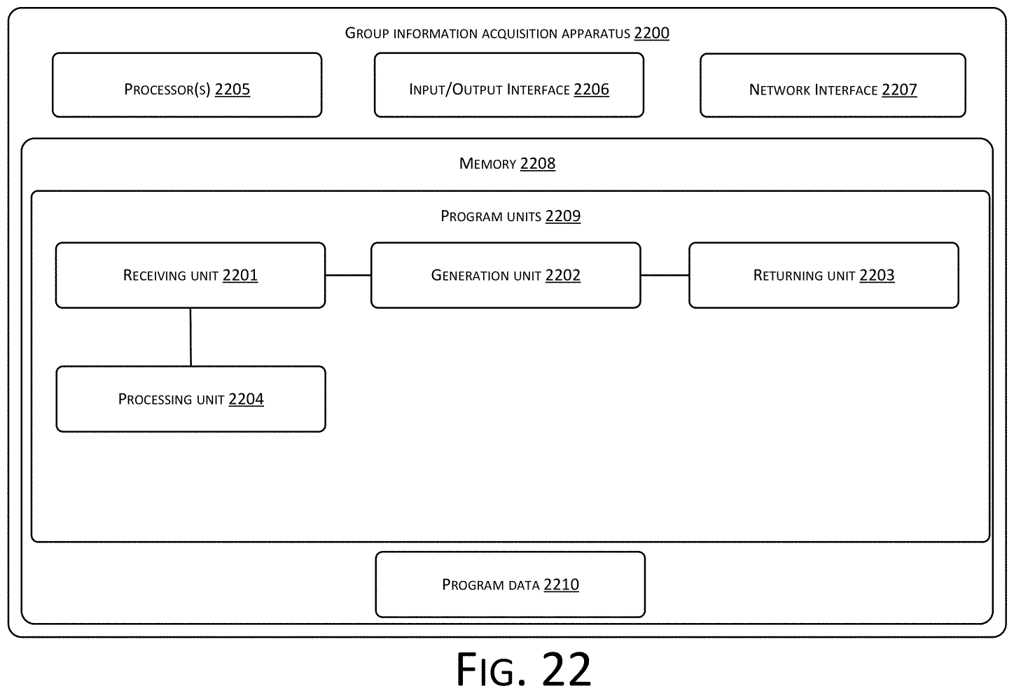

Referring to FIG. 22, an apparatus 2200 for obtaining the group information may include a receiving unit 2201, a generation unit 2202, and a returning unit 2203, wherein:

the receiving unit 2201 causes a server end of a mobile group work platform to receive an approval request, the approval request being initiated by a group member of any one registered group on the mobile group work platform to another registered group;

a generation unit that causes the server end to generate approval statistical data for at least one registered group according to an approval request for the at least one registered group; and

a returning unit that causes the server end to return page data of a function page of a group information platform to a client end of the mobile group work platform in response to receiving a page acquisition request sent by the client end, so that the client end is allowed to display the approval statistical data on the function page, wherein the function page is used for performing a centralized display of group information for the registered group of the mobile group work platform.

In implementations, the receiving unit 2201 is specifically configured to:

cause the server end to receive an approval invitation sent by a group member of the other registered group, a target party of the approval invitation being configured as a group member of the any one registered group;

cause the server end to send the approval invitation to the group member of the any one registered group, to perform an invitation prompt by the group member of the any one registered group on a specific client end corresponding to the mobile group work platform; and

cause the server end to receive prompt response information returned by the specific client end, the prompt response information including the approval request.

In implementations, the apparatus 2200 also includes:

a processing unit 2204 that ignores the approval request initiated by the group member of the any one registered group when a certification level of the any one registered group does not reach a preset level, or limits an authority of the group member of the any one registered group for initiating the approval request, wherein the certification level is positively correlated with a level of detail of the registration information of the any one registered group on the mobile group work platform.

In implementations, the apparatus 2200 may further include one or more processors 2205, an input/output (I/O) interface 2206, a network interface 2207, and a memory 2208. The memory 2208 may include a form of computer readable media as described in the foregoing description.

In implementations, the memory 2208 may include program units 2209 and program data 2210. The program units 2209 may include one or more of the foregoing units as described above and as shown in FIG. 22.

The systems, apparatuses, modules or units illustrated in the above embodiments may be implemented by a computer chip or an entity, or by a product having certain functions. A device of a typical implementation is a computer, and a specific form of the computer may be a personal computer, a laptop computer, a cellular phone, a camera phone, a smart phone, a personal digital assistant, a media player, a navigation device, an email transceiver, and a game control, a tablet computer, a wearable device, or any combination of a number of these devices.

In a typical configuration, a computer includes one or more processors (CPUs), an input/output interface, a network interface, and memory.

It also needs to be understood that terms “including”, “containing” or any other variations are intended to encompass a non-exclusive inclusion, such that a process, method, product, or device including a series of elements includes not only these elements, but also other elements that are not explicitly listed, or elements that are inherent to such process, method, product, or device. With any further limitation, an element defined by a phrase “comprising a . . . ” does not exclude the presence of additional equivalent elements in the process, method, product, or device including such element.

Exemplary embodiments are described in detail herein, examples of which are illustrated in the accompanying drawings. When accompanying drawings are involved in the following description, the same numerals in different drawings represent the same or similar elements unless indicated otherwise. The implementations described in the following exemplary embodiments do not represent all available embodiments that are consistent with the present disclosure. Rather, they are merely examples of apparatuses and methods that are consistent with aspects of the present disclosure as described in detail in the appended claims.

Terminologies used in the present disclosure are merely intended to describe particular embodiments, and are not intended to be limiting. Singular forms “a”, “the” and “said” are intended to include a plural form, unless other meanings are clearly represented in the context. It should also be understood that a term “and/or” as used herein refers to and encompasses any and all possible combinations of one or more of associated items that are listed.

It should be understood that, although the present disclosure may use terms such as “first”, “second”, “third”, etc. to describe various types of information, these pieces of information should not be limited to these terms. These terms are only used for distinguishing information of a same type from each other. For example, first information may also be referred to as second information without departing from the scope of the present disclosure. Similarly, second information may also be referred to as first information. Depending on the context, a term “if” as used herein may be interpreted as “at the time of” or “when” or “in response to determining that”.

The above description is only exemplary embodiments of the present disclosure, and is not intended to limit the present disclosure. Any modifications, equivalent replacements, improvements, etc., that are made within the spirit and principles of the present disclosure, shall be included in the scope of protection of the present disclosure.

The present disclosure can be further understood using the following clauses.

Clause 1: A group information interaction system comprising: a server, the server having a server end of an instant messaging application running therein, the server end being used for maintaining a group information platform; at least one first type of terminal, the first type of terminal belonging to a first group, wherein the first type of terminal has a client end of the instant messaging application running therein, and the running client end in the first type of terminal is logged into the instant messaging application with a registered account of a group member in the first group; and the first type of terminal detects an information uploading operation for the group information platform according to an interface of the running client end, and uploads group information of the first group to the server, to instruct the server to record the group information of the first group onto the group information platform; and at least one second type of terminal, the second type of terminal belonging to a second group different from the first group, wherein the second type of terminal has a client of the instant messaging application running therein, and the running client in the second type of terminal is logged into the instant messaging application with a registered account of the group member in the second group; and the second type of terminal detects an information acquisition operation for the group information platform according to an interface of the running client, obtains page data of the group information platform, and displays a function page of the group information platform on the running client in the second type of terminal based on the page data, the function page being used for displaying the group information recorded on the group information platform in a centralized manner.

Clause 2: A group information acquisition method comprising: detecting a triggering operation for a group information platform in an interface of a client end of an instant messaging application; sending a page acquisition request for the group information platform to a server end of the instant messaging application; and displaying a function page of the group information platform based on page data returned by the server, wherein the function page is used for performing a centralized display of group information for registered groups of the instant messaging application.

Clause 3: The method of Clause 2, wherein displaying the function page of the group information platform comprises: categorically displaying corresponding group information on the function page according to a classification result of the registered groups by the server on a preset dimension.

Clause 4: The method of Clause 3, the preset dimension comprises at least one of the following: a type of a group, an industry to which the group belongs, a region in which the group is located, a group credit status, and a degree of concern.

Clause 5: The method of Clause 2, wherein displaying the function page of the group information platform comprises: preferentially displaying group information of at least one of registered groups having a supply relationship and registered groups having a demand relationship with a group to which a sender of the page acquisition request belongs in the function page according to an analysis result obtained by the server end regarding supply and demand relationships between the group to which the sender belongs and other registered groups.

Clause 6: The method of Clause 2, wherein displaying the function page of the group information platform comprises: displaying approval statistical data made by the server for any one registered group in the function page, the approval statistical data being statistically calculated by the server end according to approval requests of group members of other registered groups that are sent for the any one registered group.

Clause 7: The method of Clause 6, wherein the approval statistical data comprises at least one of the following: a total number of the approval requests for the any one registered group, personal information of senders of the approval requests for the any one registered group, and message information of the senders of the approval requests for the any one registered group, group information of respective groups to which the senders of the approval requests for the any one registered group are located.

Clause 8: The method of Clause 6, wherein a certification level of a group to which the sender of the approval request belongs reaches a preset level, and wherein the certification level is positively correlated with a level of details of registration information of the group of the sender on the instant messaging application.

Clause 9: The method of Clause 2, further comprising: sending communication demand information for any one registered group to the server end; and receiving contact information of an intermediate communication party returned by the server end, the intermediate communication party having one or more levels of association relationships with a sender of the communication demand information and at least one contact of the any one registered group respectively.

Clause 10: The method of Clause 2, further comprising: sending a business card delivery request for any one registered group to the server end, the business card delivery request being used for instructing the server end to obtain contact information of a sender of the business card delivery request, and send the contact information to a management member of the any one registered group, so that an association relationship is established between the sender of the business card delivery request and the management member when the management member responds to the contact information.

Clause 11: The method of Clause 2, further comprising: detecting a triggering operation for group information of any one registered group that is displayed in the function page; displaying a service window page of the any one registered group, the service window page including a function identifier of a preset processing function related to the any one registered group; and initiating an information interaction request to the server end to implement an information interaction operation for the preset processing function in response to detecting a user operation for the function identifier.

Clause 12: The method of Clause 11, wherein the information interaction request is used for instructing the server end to create a communication session between an initiator of the user operation and a specific group member of the any one registered group, or between the initiator and an information processing system of the any one registered group to implement the information interaction operation based on the communication session.

Clause 13: A group information acquisition method comprising: receiving, by a server end of an instant messaging application, an approval request, the approval request being initiated by a group member of any one registered group on the instant messaging application to another registered group; generating, by the server end, approval statistical data for at least one registered group according to an approval request for the at least one registered group; and returning, by the server end, page data of a function page of a group information platform to a client end of the instant messaging application in response to receiving a page acquisition request sent by the client end, to cause the client end to display the approval statistical data on the function page, wherein the function page is used for performing a centralized display of group information for the registered group of the instant messaging application.

Clause 14: The method of Clause 13, wherein receiving the approval request by the server end of the instant messaging application comprises: receiving, by the server end, an approval invitation sent by a group member of the other registered group, a target party of the approval invitation being configured as a group member of the any one registered group; sending, by the server end, the approval invitation to the group member of the any one registered group, to perform an invitation prompt by the group member of the any one registered group on a specific client end corresponding to the mobile group work platform; and receiving, by the server end, prompt response information returned by the specific client end, the prompt response information including the approval request.

Clause 15: The method of Clause 13, further comprising: ignoring the approval request initiated by the group member of the any one registered group when a certification level of the any one registered group does not reach a preset level, or limiting an authority of the group member of the any one registered group for initiating the approval request, wherein the certification level is positively correlated with a level of detail of the registration information of the any one registered group on the mobile group work platform.

Clause 16: A group information acquisition apparatus comprising: a first detection unit that detects a triggering operation for a group information platform in an interface of a client end of an instant messaging application; a requesting unit that sends a page acquisition request for the group information platform to a server end of the mobile group work platform; and a first display unit that displays a function page of the group information platform based on page data returned by the server end, wherein the function page is used for performing a centralized display of group information of registered groups of the instant messaging application.

Clause 17: The apparatus of Clause 16, wherein the first display unit is specifically configured to: categorically display corresponding group information on the function page according to a classification result of the registered groups by the server end on a preset dimension.

Clause 18: The apparatus of Clause 17, wherein the preset dimension comprises at least one of the following: a type of a group, an industry to which the group belongs, a region in which the group is located, a group credit status, and a degree of concern.

Clause 19: The apparatus of Clause 16, wherein the first display unit is specifically configured to: preferentially display group information of at least one of registered groups having a supply relationship and registered groups having a demand relationship with a group to which a sender of the page acquisition request belongs in the function page according to an analysis result obtained by the server end regarding supply and demand relationships between the group to which the sender belongs and other registered groups.

Clause 20: The apparatus of Clause 16, wherein the first display unit is specifically configured to: display approval statistical data made by the server for any one registered group in the function page, the approval statistical data being statistically calculated by the server end according to approval requests of group members of other registered groups that are sent for the any one registered group.

Clause 21: The apparatus of Clause 20, wherein the approval statistical data comprises at least one of the following: a total number of the approval requests for the any one registered group, personal information of senders of the approval requests for the any one registered group, and message information of the senders of the approval requests for the any one registered group, group information of respective groups to which the senders of the approval requests for the any one registered group are located.

Clause 22: The apparatus of Clause 20, wherein a certification level of a group to which the sender of the approval request belongs reaches a preset level, wherein the certification level is positively correlated with a level of details of registration information of the group of the sender on the instant messaging application.

Clause 23: The apparatus of Clause 16, further comprising: a sending unit that sends communication demand information for any one registered group to the server end; and a receiving unit that receives contact information of an intermediate communication party returned by the server end, the intermediate communication party having one or more levels of association relationships with a sender of the communication demand information and at least one contact of the any one registered group respectively.

Clause 24: The apparatus of Clause 16, further comprising: a delivery unit that sends a business card delivery request for any one registered group to the server end, the business card delivery request being used for instructing the server end to obtain contact information of a sender of the business card delivery request, and send the contact information to a management member of the any one registered group, so that an association relationship is established between the sender of the business card delivery request and the management member when the management member responds to the contact information.

Clause 25: The apparatus of Clause 16, further comprising: a second detection unit that detects a triggering operation for group information of any one registered group that is displayed in the function page; a second display unit that displays a service window page of the any one registered group, the service window page including a function identifier of a preset processing function related to the any one registered group; and an interaction unit that initiates an information interaction request to the server end to implement an information interaction operation for the preset processing function in response to detecting a user operation for the function identifier.

Clause 26: The apparatus of Clause 25, wherein the information interaction request is used for instructing the server end to create a communication session between an initiator of the user operation and a specific group member of the any one registered group, or between the initiator and an information processing system of the any one registered group to implement the information interaction operation based on the communication session.

Clause 27: A group information acquisition apparatus comprising: a receiving unit that causes a server end of an instant messaging application to receive an approval request, the approval request being initiated by a group member of any one registered group on the instant messaging application to another registered group; a generation unit that causes the server end to generate approval statistical data for at least one registered group according to an approval request for the at least one registered group; and a returning unit that causes the server end to return page data of a function page of a group information platform to a client end of the mobile group work platform in response to receiving a page acquisition request sent by the client end, so that the client end is allowed to display the approval statistical data on the function page, wherein the function page is used for performing a centralized display of group information for the registered group of the instant messaging application.

Clause 28: The apparatus of Clause 27, wherein the receiving unit is specifically configured to: cause the server end to receive an approval invitation sent by a group member of the other registered group, a target party of the approval invitation being configured as a group member of the any one registered group; cause the server end to send the approval invitation to the group member of the any one registered group, to perform an invitation prompt by the group member of the any one registered group on a specific client end corresponding to the instant messaging application; and cause the server end to receive prompt response information returned by the specific client end, the prompt response information including the approval request.

Clause 29: The apparatus of Clause 27, further comprising: a processing unit that ignores the approval request initiated by the group member of the any one registered group when a certification level of the any one registered group does not reach a preset level, or limits an authority of the group member of the any one registered group for initiating the approval request, wherein the certification level is positively correlated with a level of detail of the registration information of the any one registered group on the instant messaging application.

What is claimed is:

1. A method implemented by one or more computing devices, the method comprising:
detecting a triggering operation for a group information platform in an interface of a client end of an instant messaging application;
sending a page acquisition request for the group information platform to a server end of the instant messaging application; and
displaying a function page of the group information platform based on page data returned by the server, wherein the function page is used for performing a centralized display of group information for registered groups of the instant messaging application.

2. The method of claim 1, wherein displaying the function page of the group information platform comprises:
categorically displaying corresponding group information on the function page according to a classification result of the registered groups by the server on a preset dimension.

3. The method of claim 2, the preset dimension comprises at least one of: a type of a group, an industry to which the group belongs, a region in which the group is located, a group credit status, and a degree of concern.

4. The method of claim 1, wherein displaying the function page of the group information platform comprises:
preferentially displaying group information of at least one of registered groups having a supply relationship and registered groups having a demand relationship with a group to which a sender of the page acquisition request belongs in the function page according to an analysis result obtained by the server end regarding supply and demand relationships between the group to which the sender belongs and other registered groups.

5. The method of claim 1, wherein displaying the function page of the group information platform comprises:
displaying approval statistical data made by the server for any one registered group in the function page, the approval statistical data being statistically calculated by the server end according to approval requests of group members of other registered groups that are sent for the any one registered group.

6. The method of claim 5, wherein the approval statistical data comprises at least one of: a total number of the approval requests for the any one registered group, personal information of senders of the approval requests for the any one registered group, and message information of the senders of the approval requests for the any one registered group, group information of respective groups to which the senders of the approval requests for the any one registered group are located.

7. The method of claim 5, wherein a certification level of a group to which the sender of the approval request belongs reaches a preset level, and wherein the certification level is positively correlated with a level of details of registration information of the group of the sender on the instant messaging application.

8. The method of claim 1, further comprising:
sending communication demand information for any one registered group to the server end; and
receiving contact information of an intermediate communication party returned by the server end, the intermediate communication party having one or more levels of association relationships with a sender of the communication demand information and at least one contact of the any one registered group respectively.

9. The method of claim 1, further comprising:
sending a business card delivery request for any one registered group to the server end, the business card delivery request being used for instructing the server end to obtain contact information of a sender of the business card delivery request, and send the contact information to a management member of the any one registered group, so that an association relationship is established between the sender of the business card delivery request and the management member when the management member responds to the contact information.

10. The method of claim 1, further comprising:
detecting a triggering operation for group information of any one registered group that is displayed in the function page;
displaying a service window page of the any one registered group, the service window page including a function identifier of a preset processing function related to the any one registered group; and
initiating an information interaction request to the server end to implement an information interaction operation for the preset processing function in response to detecting a user operation for the function identifier.

11. The method of claim 10, wherein the information interaction request is used for instructing the server end to create a communication session between an initiator of the user operation and a specific group member of the any one registered group, or between the initiator and an information processing system of the any one registered group to implement the information interaction operation based on the communication session.

12. One or more computer readable media storing executable instructions that, when executed by a server end of an instant messaging application, cause the server end to perform acts comprising:
receiving an approval request, the approval request being initiated by a group member of any one registered group on the instant messaging application to another registered group;
generating approval statistical data for at least one registered group according to an approval request for the at least one registered group; and
returning page data of a function page of a group information platform to a client end of the instant messaging application in response to receiving a page acquisition request sent by the client end, to cause the client end to display the approval statistical data on the function page, wherein the function page is used for performing a centralized display of group information for the registered group of the instant messaging application.

13. The one or more computer readable media of claim 12, wherein receiving the approval request by the server end of the instant messaging application comprises:
receiving an approval invitation sent by a group member of the other registered group, a target party of the approval invitation being configured as a group member of the any one registered group;
sending the approval invitation to the group member of the any one registered group, to perform an invitation prompt by the group member of the any one registered group on a specific client end corresponding to the mobile group work platform; and
receiving prompt response information returned by the specific client end, the prompt response information including the approval request.

14. The one or more computer readable media of claim 12, the acts further comprising:
ignoring the approval request initiated by the group member of the any one registered group when a certification level of the any one registered group does not reach a preset level, or limiting an authority of the group member of the any one registered group for initiating the approval request, wherein the certification level is positively correlated with a level of detail of the registration information of the any one registered group on the mobile group work platform.

15. An apparatus comprising:
one or more processors;
memory;
a first detection unit stored in the memory and executable by the one or more processors to detect a triggering operation for a group information platform in an interface of a client end of an instant messaging application;
a requesting stored in the memory and executable by the one or more processors to send a page acquisition request for the group information platform to a server end of the mobile group work platform; and
a first display unit stored in the memory and executable by the one or more processors to display a function page of the group information platform based on page data returned by the server end, wherein the function page is used for performing a centralized display of group information of registered groups of the instant messaging application.

16. The apparatus of claim 15, wherein the first display unit is further configured to:
categorically display corresponding group information on the function page according to a classification result of the registered groups by the server end on a preset dimension.

17. The apparatus of claim 15, wherein the first display unit is further configured to:
preferentially display group information of at least one of registered groups having a supply relationship and registered groups having a demand relationship with a group to which a sender of the page acquisition request belongs in the function page according to an analysis result obtained by the server end regarding supply and demand relationships between the group to which the sender belongs and other registered groups.

18. The apparatus of claim 15, wherein the first display unit is further configured to:
display approval statistical data made by the server for any one registered group in the function page, the approval statistical data being statistically calculated by the server end according to approval requests of group members of other registered groups that are sent for the any one registered group.

19. The apparatus of claim 15, further comprising:
a sending unit that sends communication demand information for any one registered group to the server end; and
a receiving unit that receives contact information of an intermediate communication party returned by the server end, the intermediate communication party having one or more levels of association relationships with a sender of the communication demand information and at least one contact of the any one registered group respectively.

20. The apparatus of claim 15, further comprising:
a delivery unit that sends a business card delivery request for any one registered group to the server end, the business card delivery request being used for instructing the server end to obtain contact information of a sender of the business card delivery request, and send the contact information to a management member of the any one registered group, so that an association relationship is established between the sender of the business card delivery request and the management member when the management member responds to the contact information.
